(19) United States
(12) Patent Application Publication
(10) Pub. No.: US 2026/0353088 A1
(43) Pub. Date: Nov. 5, 2026

(54) A METHOD AND USER EQUIPMENT FOR DETERMINING FALSE NETWORK NODE IN WIRELESS NETWORK

(71) Applicant: Samsung Electronics Co., Ltd., Gyeonggi-do (KR)

(72) Inventors: Sriganesh RAJENDRAN, Tamil Nadu (IN); Vinay Kumar SHRIVASTAVA, Bengaluru (IN); Rajavelsamy RAJADURAI, Bengaluru (IN); Jaehyuk JANG, Gyeonggi-do (KR)

(21) Appl. No.: 19/099,332

(22) PCT Filed: Aug. 2, 2023
(86) PCT No.: PCT/KR2023/011331

§ 371 Date: Jan. 28, 2025

(30) Foreign Application Priority Data
Aug. 9, 2022 (IN) 202241045477
Aug. 12, 2022 (IN) 202241046176
Aug. 18, 2022 (IN) 202241046976
Aug. 19, 2022 (IN) 202241047381

(51) Int. Cl. H04W 12/122; H04W 36/30

(52) U.S. Cl. CPC H04W 12/122; H04W 36/30

(57) ABSTRACT

The disclosure relates to a 5G or 6G communication system for supporting a higher data transmission rate. According to an embodiment of the disclosure, the method may include determining that the UE (100) is configured or capable for security protection of at least one system information, receiving first system information from a cell of at least one network node, determining at least one scheduling parameter of second system information for the cell of at least one network node from the first system information, receiving the second system information including the security information of the at least one network node based on the at least one scheduling parameter and determining that the at least one network node is false when validation of the at least one of the first system information and the second system information of the cell including the security information is failed.

### TECHNICAL FIELD

Embodiments herein relate to a wireless communication, more specifically relate to a method and a user equipment for determining false network node in a wireless network. This application claims priority from a list of Indian Provisional Application Number 202241045477 filed on 9 Aug. 2022, 202241046176 filed on 12 Aug. 2022, 202241046976 filed on 18 Aug. 2022 and 202241047381 filed on 19 Aug. 2022 the disclosure of which is hereby incorporated by reference herein.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

The principal object of the embodiments herein is to determine one or more false network nodes in a wireless network.

Another object of the embodiment herein is to determine a first system information from a cell of one or more network nodes in the wireless communication and determine one or more scheduling parameters of a second system information for the cell of one or more network nodes from the first system information, where the second system information comprises a security information.

Yet another object of the embodiment herein is to determine that the one or more network nodes is false when the validation of the at least one of the first system information and the second system information of the cell with the security information is failed.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 illustrates a block diagram of a UE for determining at least one false network node in a wireless network, according to an embodiment as disclosed herein;

FIG. 2 is a flow diagram illustrating a method for determining the at least one false network node in the wireless network, according to an embodiment as disclosed herein;

FIG. 3 is a flow diagram illustrating a method for verifying a system information using a security information scheduled on a New System Information Block (SIBx), according to an embodiment as disclosed herein;

FIG. 4 is a flow diagram illustrating a method for verifying the system information while performing cell reselection, according to an embodiment as disclosed herein;

FIG. 5 is a sequence diagram illustrating a signaling flow for an exchange between UE and network for the security protection/verification for system information, according to an embodiment as disclosed herein;

FIG. 6 is a sequence diagram illustrating a scenario of procedural flow of UE to perform connection establishment and handling the system information validation, according to the embodiments as disclosed herein;

FIG. 7 is a sequence diagram illustrating a scenario of UE handling SI validation of all SI messages, according to the embodiments as disclosed herein;

FIG. 8 is a sequence diagram illustrating a scenario of signaling between gNB and UE to perform logging and a False Base Station (FBS) related reporting, according to the embodiments as disclosed herein;

FIG. 9 is a sequence diagram illustrating a scenario of signalling from Core Network to release a legacy UE connected to the FBS, according to the embodiments as disclosed herein;

FIG. 10 is a sequence diagram illustrating signalling of the support for FBS identification and mitigation, according to an embodiment as disclosed herein;

FIG. 11 is a sequence diagram illustrating signalling of the support for FBS identification and mitigation using a RRC message, according to an embodiment as disclosed herein;

FIG. 12 is a sequence diagram illustrating signalling of the support for FBS identification/mitigation and verify the authenticity of a selected cell, according to an embodiment as disclosed herein;

FIG. 13 is a sequence diagram illustrating signalling of the support for FBS identification and mitigation to know the information of other cells, according to an embodiment as disclosed herein;

FIG. 14 is a flow diagram illustrating an operational flow for verifying the system information received on the serving cell for authenticity and replay protection/verification, according to an embodiment as disclosed herein;

FIG. 15 is a flow diagram illustrating a method to avoid the SFN mismatch of the MIB and an acquired DS, according to an embodiment as disclosed herein;

FIG. 16 is a flow diagram illustrating a method for matching SIB with the SFN in the stored MIB, according to an embodiment as disclosed herein;

FIG. 17 is a flow diagram illustrating a method of validation of SIB by generating a version of modified MIB, according to an embodiment as disclosed herein;

FIG. 18 is a flow diagram illustrating the modified MIB used for validation of MIB by replacing the SFN information when the network does not signal the SFN information, according to an embodiment as disclosed herein;

FIG. 19a is schematic diagram illustrating scheduling of MIB, SIB1 and other SIBs in a SI message, according to a prior art;

FIG. 19b is schematic diagram illustrating the signaling of security information of MIB, SIB1 and other SIBs as part of SIBx, according to an embodiment as disclosed herein;

FIG. 19c is schematic diagram illustrating the signaling of security information of MIB, SIB1 and other SIBs as part of SI message container, according to an embodiment as disclosed herein;

FIG. 19d is schematic diagram illustrating the signaling of security information of MIB, SIB1 and other SIBs as part of SI message container, according to an embodiment as disclosed herein;

FIG. 19e is schematic diagram illustrating the scheduling of security information of MIB and SIB1 as part of a higher periodic SI message container and security information of other SIBs, according to an embodiment as disclosed herein.

FIG. 20 illustrates a block diagram of a network node according to an embodiment as disclosed herein.

### BEST MODE FOR CARRYING OUT THE INVENTION

The embodiments herein provide a method for determining one or more false network nodes in a wireless network by a User Equipment (UE). The method includes determining, by the UE, that the UE is at least one of configured and capable for security protection of at least one system information. The method further includes receiving, by the UE, the first system information from a cell of one or more network nodes in the wireless communication. The method further includes determining, by the UE, one or more scheduling parameters of a second system information for the cell of one or more network nodes from the first system information, where the second system information comprises a security information. The method further includes receiving, by the UE, the second system information with the security information of the one or more network nodes based on the one or more scheduling parameters. The method further includes determining, by the UE, that the one or more network nodes is false when the validation of the at least one of the first system information and the second system information of the cell with the security information is failed.

In an embodiment, the method includes determining, by the UE, whether the one or more network nodes is false by validating at least one of the first system information and the second system information with the security information. The method further includes reselecting to other cell when the validation of the at least one of the first system information and the second system information of the cell with the security information is failed. The method further includes continuing the connection with cell of the one or more network nodes when the validation of the at least one of the first system information and the second system information of the cell with the security information is success.

In an embodiment, the method includes measuring, by the UE, a signal strength for a serving cell and one or more neighboring cells. The method further includes determining, by the UE, whether the signal strength of the one or more neighboring cells is larger than the signal strength of the serving cell. The method further includes reselecting to the one or more neighboring cells when the signal strength of the one or more neighboring cells is larger than the signal strength of the serving cell and discarding the security information of the serving cell and determine security information of the one or more neighboring cells. The method further includes continuing the connection with the serving cell when the signal strength of the one or more neighboring cells is not larger than the signal strength of the serving cell.

In an embodiment, the first system information comprises at least one of a Master Information Block (MIB), a System Information Block index 1 (SIB1) and other System Information Blocks.

In an embodiment, the second system information comprises at least one of Existing System information block (SIB) and New System Information Block (SIBx).

In an embodiment, the one or more scheduling parameters comprises at least one of periodicity of the SIBx, broadcast status of the SIBx, support of an on-demand delivery of SIBx, a scope of security protection or verification in the cell or an area of the wireless network.

In an embodiment, the method includes transmitting, by the UE, a request message through a dedicated signaling to the one or more network nodes. The method further includes receiving, by the UE, a response message from the one or more network nodes through the dedicated signaling comprising the scheduling parameters.

Accordingly, the embodiment herein is to provide the UE for determining the one or more false network nodes in the wireless network, comprises a memory; a processor; and a validate controller. The validate controller is configured to determine that the UE is at least one of configured and capable for security protection of the at least one system information. Further, the validate controller is configured to receive the first system information from the cell of one or more network nodes in the wireless communication. Further, the validate controller is configured to determine the one or more scheduling parameters of the second system information for the cell of one or more network nodes from the first system information; wherein the second system information comprises the security information. Further, the validate controller is configured to receive the second system information with the security information of the one or more network nodes based on the one or more scheduling parameters. Further, the validate controller is configured to determine that the one or more network nodes is false when the validation of the at least one of the first system information and the second system information of the cell with the security information is failed.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein, and the embodiments herein include all such modifications.

### MODE FOR THE INVENTION

The embodiments herein, the various features, and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

In recent past, wireless communication plays a vital role in modern society and has numerous impacts on various sectors, including business, education, healthcare, transportation, and entertainment. It enables instant communication, remote collaboration, access to information and services, and global connectivity. In the wireless communication, security is of paramount importance. In current situation, security of the wireless communication is facing concerns due to false (fake) base stations, where the false base station is a device that impersonates a cellular base station to intercept and manipulate communications from mobile devices. The false base station tricks nearby mobile devices into connecting to it by emitting a stronger signal as the cellular base station.

The conventional systems and methods discloses validation of a system information to verify the cellular base station, however the conventional systems and method failed to disclose anything related a scheduling of security information to validate the system information for verifying the cellular base station.

Thus, it is desired to address the above-mentioned disadvantages or other shortcomings or at least provide a useful alternative for motion-based image enhancement.

Accordingly, the embodiments herein provide a method for determining one or more false network nodes in a wireless network by a User Equipment (UE) (100). The method includes determining, by the UE (100), that the UE (100) is at least one of configured and capable for security protection of at least one system information. The method further includes receiving, by the UE (100), the first system information from a cell of one or more network nodes in the wireless communication. The method further includes determining, by the UE (100), one or more scheduling parameters of a second system information for the cell of one or more network nodes from the first system information, where the second system information comprises a security information. The method further includes receiving, by the UE (100), the second system information with the security information of the one or more network nodes based on the one or more scheduling parameters. The method further includes determining, by the UE (100), that the one or more network nodes is false when the validation of the at least one of the first system information and the second system information of the cell with the security information is failed.

Accordingly, the embodiments herein provide the UE (100) for determining the one or more false network nodes in the wireless network, comprises a memory; a processor; and a validate controller (140). The validate controller (140) is configured to determine that the UE (100) is at least one of configured and capable for security protection of the at least one system information. Further, the validate controller (140) is configured to receive the first system information from the cell of one or more network nodes in the wireless communication. Further, the validate controller (140) is configured to determine the one or more scheduling parameters of the second system information for the cell of one or more network nodes from the first system information; wherein the second system information comprises the security information. Further, the validate controller (140) is configured to receive the second system information with the security information of the one or more network nodes based on the one or more scheduling parameters. Further, the validate controller (140) is configured to determine that the one or more network nodes is false when the validation of the at least one of the first system information and the second system information of the cell with the security information is failed.

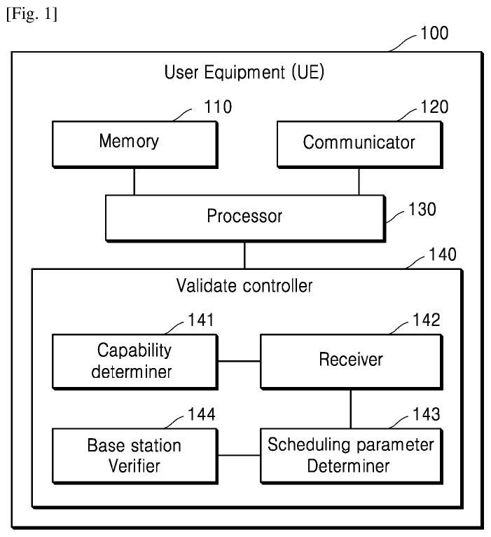

Referring to FIGS. 1 through 20, where similar reference characters denote corresponding features consistently throughout the figures, there are shown preferred embodiments.

FIG. 1 illustrates a block diagram of a UE (100) for determining at least one false network node in a wireless network, according to an embodiment as disclosed herein. The UE (100) can be, for example, but is not limited to a smart phone, a laptop, a desktop, a smart watch, a smart TV, an Augmented Reality device (AR device), a Virtual Reality device (VR device), Internet of Things (IoT) device or a like.

In an embodiment, the UE (100) includes a memory (110), a processor (130), a communicator (120), and a validate controller (140).

In an embodiment, the memory (110) stores a plurality of image frames with a subject(s), a plurality of key points associated with the subject(s). The memory (110) stores instructions to be executed by the processor (130). The memory (110) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (110) may, in some examples, be considered a non-transitory storage medium. The term “non-transitory” may indicate that the storage medium is not embodied in a carrier wave or a propagated signal. However, the term “non-transitory” should not be interpreted that the memory (110) is non-movable. In some examples, the memory (110) can be configured to store larger amounts of information than the memory. In certain examples, a non-transitory storage medium may store data that can, over time, change (e.g., in Random Access Memory (RAM) or cache). The memory (110) can be an internal storage unit or it can be an external storage unit of the user equipment (100), a cloud storage, or any other type of external storage.

The processor (130) communicates with the memory (110), the communicator (120) and the validate controller (140). The processor (130) is configured to execute instructions stored in the memory (110) and to perform various processes. The processor (130) may include one or a plurality of processors, maybe a general-purpose processor, such as a Central Processing Unit (CPU), an Application Processor (AP), or the like, a Graphics-only Processing Unit such as a graphics processing unit (GPU), a Visual Processing Unit (VPU), and/or an Artificial Intelligence (AI) dedicated processor such as a Neural Processing Unit (NPU).

The communicator (120) is configured for communicating internally between internal hardware components and with external devices (e.g. server) via one or more networks (e.g. Radio technology). The communicator (120) includes an electronic circuit specific to a standard that enables wired or wireless communication. In this disclosure, the communication module 108 is also explained as a transceiver.

The validate controller (140) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the validate controller (140) includes a capability determiner (141), a receiver (142), a scheduling parameter determiner (143) and a base station Verifier (144). The capability determiner (141) determines that the UE (100) is at least one of configured and capable for security protection of at least one system information. The receiver (142) receives the first system information from a cell of at least one network node in the wireless communication. The scheduling parameter determiner (143) determines at least one scheduling parameter of a second system information for the cell of at least one network node from the first system information, where the second system information comprises a security information. The receiver (142) receive the second system information with the security information of the at least one network node based on the at least one scheduling parameter. The base station Verifier (144) determines that the at least one network node is false when the validation of the at least one of the first system information and the second system information of the cell with the security information is failed.

In an embodiment, the validate controller (140) is configured to determine whether the at least one network node is false by validating at least one of the first system information and the second system information with the security information. Further, the validate controller (140) is configured to reselect to other cell when the validation of the at least one of the first system information and the second system information of the cell with the security information is failed. Further, the validate controller (140) is configured to continue the connection with cell of the at least one network node when the validation of the at least one of the first system information and the second system information of the cell with the security information is success.

In an embodiment, the validate controller (140) is configured to measure a signal strength for a serving cell and at least one neighboring cell. Further, the validate controller (140) is configured to determine whether the signal strength of the at least one neighboring cell is larger than the signal strength of the serving cell.

Further, the validate controller (140) is configured to reselect to the at least one neighboring cell when the signal strength of the at least one neighboring cell is larger than the signal strength of the serving cell; and discarding the security information of the serving cell and determine security information of the at least one neighboring cell. Further, the validate controller (140) is configured to continue the connection with the serving cell when the signal strength of the at least one neighboring cell is not larger than the signal strength of the serving cell.

In an embodiment, the first system information comprises at least one of a Master Information Block (MIB), a System Information Block index 1 (SIB1) and other System Information Blocks.

In an embodiment, the second system information comprises at least one of Existing System information block (SIB) and New System Information Block (SIBx).

In an embodiment, the at least one scheduling parameter comprises at least one of periodicity of the SIBx, broadcast status of the SIBx, support of an on-demand delivery of SIBx, a scope of security protection or verification in the cell or an area of the wireless network.

In an embodiment, the validate controller (140) is configured to transmit a request message through a dedicated signaling to the at least one network node. Further, the validate controller (140) is configured to receive a response message from the at least one network node through the dedicated signaling comprising the scheduling parameters.

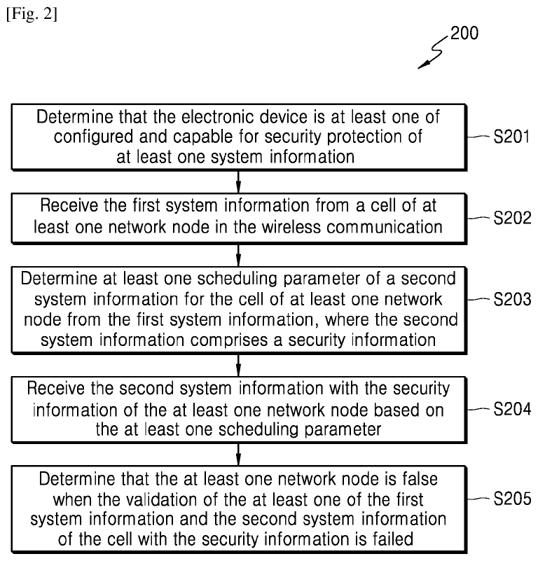

FIG. 2 is a flow diagram (200) illustrating a method for determining the at least one false network node in the wireless network, according to an embodiment as disclosed herein.

At step S201, the validate controller (140) is determines that the UE (100) is at least one of configured and capable for security protection of the at least one system information.

At step S202, the validate controller (140) is configured to receive the first system information from the cell of one or more network nodes in the wireless communication.

At step S203, the validate controller (140) is configured to determine the one or more scheduling parameters of the second system information for the cell of one or more network nodes from the first system information, where the second system information comprises the security information.

At step S204, the validate controller (140) is configured to receive the second system information with the security information of the one or more network nodes based on the one or more scheduling parameters.

At step S205, the validate controller (140) is configured to determine that the one or more network nodes is false when the validation of the at least one of the first system information and the second system information of the cell with the security information is failed.

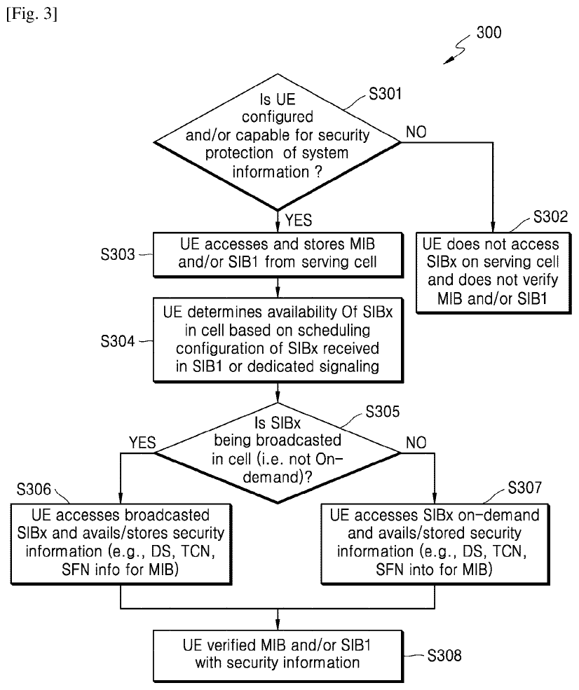

FIG. 3 is a flow diagram (300) illustrating a method for verifying the system information using the security information scheduled on the SIBx, according to an embodiment as disclosed herein.

At step S301, determines that the UE (100) is at least one of configured and capable for security protection of the at least one system information.

At step S302, the UE (100) does not access the SIBx on the serving cell and does not verify MIB and/or SIB1, when the UE (100) is not at least one of configured and capable for security protection of the at least one system information.

At step S303, the UE (100) accesses and stores MIB and/or SIB1 from serving cell when the UE (100) is at least one of configured and capable for security protection of the at least one system information.

At step S304, the UE (100) determines availability of SIBx in cell based on the scheduling parameters of SIBx received in SIB1 or dedicated signaling. The scheduling parameters is otherwise referred as scheduling configuration.

At step S305, the UE (100) determines whether the SIBx being broadcasted in cell and not on-demand.

At step S306, the UE (100) accesses broadcasted SIBx and avails/stores security information (e.g., DS, TCN, SFN info for MIB) when the SIBx being broadcasted in cell and not on-demand.

At step S307, the UE (100) accesses SIBx on-demand and avails/stored security information (e.g., DS, TCN, SFN into for MIB) when the SIBx not broadcasted in cell but on-demand.

At step S308, the UE (100) verified the MIB and/or the SIB1 with the security information.

In an embodiment, the network node including, but not limited to Radio Access Network (RAN) node, base station, gNB, Core Network (CN) node and Access and Mobility Function (AMF) provides the UE (100) with at least one pre-configured scheduling parameter of the security information delivery for the verification of the authenticity of the one or more of Master information block (MIB), System Information Block index 1 (SIB1), other System Information Block(s). The security information may comprise of at least one of Digital Signature (DS), timing counter information (e.g. time at which the security information is transmitted (transmission slot) in order to prevent replay attacks), timing information of the MIB (e.g. 6 MSB bits of the 10 bit System Frame Number (SFN) of the MIB with which the digital signature is computed).

In an embodiment, the security information for the protection/verification of the system information is carried or delivered in an existing system information block (e.g. SIB4 or SIB9). Further, when an existing SIB is utilized to carry security information, the SIB scope is limited to the serving cell, similar to SIB1. That is, area scope field for existing SIB may be absent.

In an embodiment, the security information for the protection/verification of the system information is carried or delivered in a new system information block (i.e. SIBx). The pre-configured scheduling parameter can be at least one of the periodicity of the SIBx, broadcast status of the SIBx, support of on-demand delivery of SIBx, scope of security protection/verification in the network area which can be at least one of a radio cell or multiple cells of the gNB, SI area or a Tracking Area (TA), RAN based notification Area (RNA), a Public Land Mobile Network (PLMN) or one or more shared PLMNs. Further, the SIBx scope is limited to the serving cell, similar to SIB1. That is, areaScope field for SIBx may be absent.

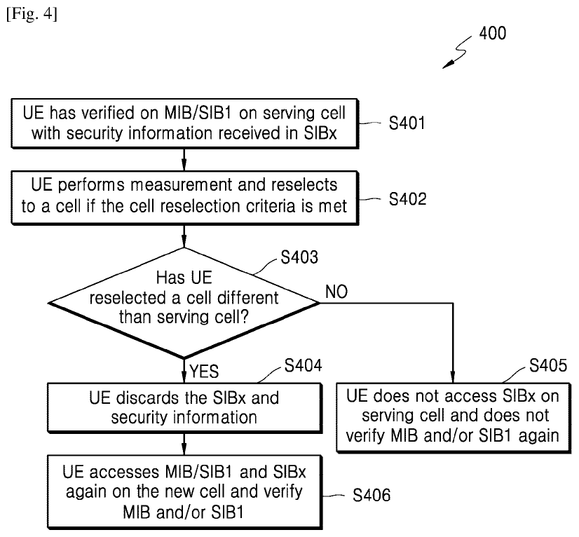

FIG. 4 is a flow diagram (400) illustrating a method for verifying the system information while performing cell reselection, according to an embodiment as disclosed herein.

At step S401, the UE (100) has verified on the MIB/SIB1 on serving cell with the security information received in SIBx.

At step S402, the UE (100) performs measurement and reselects to a cell if the cell reselection criteria is met.

At step S403, the UE (100) determines whether the UE (100) is reselected a cell different then serving cell.

At step S404, the UE (100) does not access SIBx on serving cell and does not verify MIB and/or SIB1 again when the UE (100) is not reselected the cell different then the serving cell.

At step S405, the UE (100) discards the SIBx and security information when the UE (100) is reselected the cell different then the serving cell.

At step S406, the UE (100) accesses MIB/SIB1 and SIBx again on the new cell and verify MIB and/or SIB1.

In an embodiment, at least one scheduling parameter for the SIBx is pre-specified e.g. it is specified in the 3GPP specification to one or more fixed value(s).

In an embodiment, at least one scheduling parameter for the SIBx is provided to the UE (100) in the dedicated signaling message (e.g. RRC signaling message like RRC reconfiguration, Security Mode command or NAS signaling message like Attach Accept, Security Mode command, Registration Accept). For example, when the UE (100) initially registers to a network (510) and sends registration request, the network (510) can inform UE (100) about the support of the security protection/verification for system information, one of the periodicity of the SIBx, broadcast status of the SIBx, support of on-demand delivery of SIBx in the network (510) area which can be at least one of a radio cell or multiple cells of the gNB or SI area or a TA, RNA, a PLMN or one or more shared PLMNs.

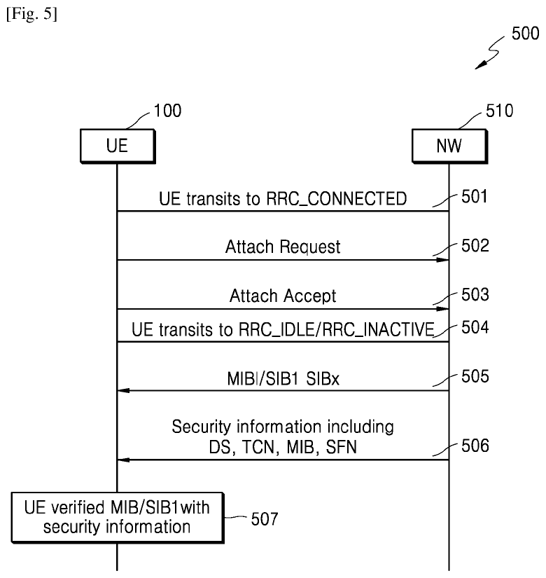

FIG. 5 is a sequence diagram illustrating the signaling flow for the exchange between the UE (100) and the network (510) for the security protection/verification for the system information, according to an embodiment as disclosed herein.

At step 501, the UE (100) transits to RRC_CONNECTED and connects with the network (510).

At step 502, the UE (100) sends Attach Request to the network (510) with Security support.

At step 503, the UE (100) sends attach accept to the network (510), wherein attach accept comprises Security protection support, scope, Area, broadcast SIB support, On-demand Support.

At step 504, the UE (100) transits to RRC_IDLE/RRC_INACTIVE mode.

At step 505, the UE (100) receives MIB/SIB1 along with SIBx from the network (510).

At step 506, the UE (100) receives Security information including DS, TCN, MIB, and SFN using the SIBx.

At step 507, the UE (100) verifies the MIB/SIB1 with the security information.

In an embodiment, UE (100) indicates to the network about its capability and/or support for authenticity verification of the system information in at least one of UE (100) capability message, UE (100) Assistance Information (UAI) message, attach request message or registration request message.

In an embodiment, the at least one scheduling parameter for the SIBx is provided to the UE (100) in the existing system information block. For example, SIB1 carries one of the scheduling information broadcast status of the SIBx and/or support of on-demand delivery of SIBx. As SIB1 contents is in turn needs to be verified by the security information in the SIBx, once the UE (100) receives the SIBx, UE (100) utilizes the DS and public key to verify the MIB and/or SIB1 contents. If the SIB 1 verification is successful with the SIBx contents, UE (100) considers the cell as authentic and SIBx as valid. UE (100) maintains the stored MIB and/or SIB1 and/or SIBx. If the SIB 1 verification is failure with the SIBx contents, UE (100) considers the cell as un-authentic (i.e. FBS attack) and SIBx as invalid. UE (100) discards the stored MIB and/or SIB1 and/or SIBx.

In an embodiment, SIBx is verified for authenticity with the security information (e.g. digital signature, timing information) contained in the received SIBx.

In an embodiment, security information (e.g. digital signature, timing information) for the authenticity verification of at least one existing SIB or a new SIB is provided in the respective SIB itself.

In an embodiment, Scheduling Information for SIBx is provided in SIB1. An example specification structure is illustrated as follows:

| | |
|---|---|
| SI-SchedulingInfo := | SEQUENCE |

{

| | |
|---|---|
| schedulingInfoList | SEQUENCE (SIZE (1..maxSI-Message)) OF |

SchedulingInfo,

| | |
|---|---|
| si-WindowLength | ENUMERATED {s5, s10, s20, s40, s80, s160, |

s320, s640, s1280, s2560-v1710, s5120-v1710 },

| | |
|---|---|
| si-RequestConfig | SI-RequestConfig |

OPTIONAL, -- Cond MSG-1

| | |
|---|---|
| si-RequestConfigSUL | SI-RequestConfig |

OPTIONAL, -- Cond SUL-MSG-1

| | |
|---|---|
| systemInformationAreaID | BIT STRING (SIZE (24)) |

```
OPTIONAL, -- Need R
    ...
  }
```

| | |
|---|---|
| SI-SchedulingInfo-v1800:= | SEQUENCE { |
| schedulingInfoList3-r18 | SEQUENCE (SIZE (1..maxSI-Message)) OF |

SchedulingInfo3-r18,

| | |
|---|---|
| si-RequestConfig-DS-r18 | SI-RequestConfig |

OPTIONAL -- Cond DS-MSG-1
}

| | |
|---|---|
| SchedulingInfo3-r18 := | SEQUENCE { |
| si-BroadcastStatus-r18 | ENUMERATED {broadcasting, |

notBroadcasting},

| | |
|---|---|
| si-WindowPosition-r18 | INTEGER (1..256), |
| si-Periodicity-r18 | ENUMERATED {rf8, rf16, rf32, rf64, rf128, |

rf256, rf512},

| | |
|---|---|
| sib-MappingInfo-r18 | SIB-Mapping-v1800 |

}

| | |
|---|---|
| SIB-Mapping-v1800 := | SEQUENCE (SIZE (1..maxSIB)) OF SIB-TypeInfo- |

v1800

| | |
|---|---|
| SIB-TypeInfo-v1800 := | SEQUENCE { |
| sibType-r18 | CHOICE { |
| type1-r18 | ENUMERATED {sibTypeX, spare15, |

```
spare14, spare13, spare12, spare11, spare10,spare9, spare8, spare7, spare6, spare5, spare4, spare3,
spare2, spare1,...},
  OPTIONAL -- Need R
      }
    },
```

| | |
|---|---|
| valueTag-r18 | INTEGER (0..31) |

OPTIONAL, -- Cond NonPosSIB

| | |
|---|---|
| areaScope-r18 | ENUMERATED {true} |

OPTIONAL -- Need S
}

In an embodiment, the UE (100) is configured with si-RequestConfig-DS in Scheduling information for SIBx to configure the Msg1 (i.e. RACH preamble transmission) resources that the UE (100) uses for requesting SI messages including the SIBx for which si-BroadcastStatus is set to “notBroadcasting”. The resources includes at least one of RACH preamble start index, RACH association period index, RACH SSB occasion Mask index, SI request period, SSB per RACH occasion and generic RACH configuration parameters.

In an embodiment, when UE (100) needs to avail SIBx on demand and/or criteria to select uplink carrier is not satisfied, UE (100) transmits RRCSystemInfoRequest message to request SI message including SIBx. UE (100) sets the corresponding bit in the requested-SI-List field in RRCSystemInfoRequest message to indicate the SI message including SIBx and transmit RRCSystemInfoRequest message on UL Common Control Channel (UL CCCH).

In an embodiment, the UE (100) requests for required SIBs using the RRCSystemInfoRequest message and also requests for security information (e.g. Digital Signature, DS) for all the requested SIBs or selected SIBs as part of the same RRCSystemInfoRequest message or a different RRC message. In an embodiment, the network (510) provides the UE (100) along with the requested SIBs, a single DS for all the request SIBs or individual DS of the SIBs for which UE (100) had requested to verify the authenticity of SIBs.

| | |
|---|---|
| RRCSystemInfoRequest := | SEQUENCE { |
| criticalExtensions | CHOICE { |
| rrcSystemInfoRequest | RRCSystemInfoRequest-IEs, |
| criticalExtensionsFuture-r16 | CHOICE { |
| rrcPosSystemInfoRequest-r16 | RRC-PosSystemInfoRequest-r16-IEs, |
| criticalExtensionsFuture-r18 | CHOICE { |
| rrcSystemInfoRequest-r18 | RRCSystemInfoRequest-r18-IEs, |
| criticalExtensionsFuture | SEQUENCE{ } |

```
          }
        }
      }
  }
```

| | |
|---|---|
| RRCSystemInfoRequest-r18-IEs := | SEQUENCE { |
| requested-DS-SI-List | BIT STRING (SIZE (maxSI-Message)), |

--32bits

| | |
|---|---|
| spare | BIT STRING (SIZE (10)) |

}

requested-DS-SI-List: Contains a list of requested SI messages for which Digital Signature is required. According to the order of entry in the list of SI messages configured by schedulingInfoList in si-SchedulingInfo in SIB1, first bit corresponds to first/leftmost listed SI message, second bit corresponds to second listed SI message, and the like.

In an embodiment, UE (100) is not configured with a scheduling information of the SIBx. Further, UE (100) blindly decodes and determines the presence of the SIBx when a received SI comprises of SIBx.

In an embodiment, UE (100) in RRC_IDLE and RRC_INACTIVE ensures having a valid version of at least MIB, SIB1 and SIBx when UE (100) is configured and/or capable to receive security information for authenticity verification of the system information.

In an embodiment, the security information for the protection/verification of the other system information (e.g. other than SIB) is provided by SIBx. In case areaScope (e.g. scope may be one or more cells) of other SIB is different than the SIBx (e.g. SIBx does not have areaScope or SIBx is limited to serving cell only), the verification of the other SIB is not required in its areaScope in spite of SIBx needs to be availed again when the cell reselection happens.

In an embodiment, SIBx is provided to the UE (100) with the SIB segmentation feature support. That is, SIBx can be delivered in one or more segments of the RRC message and each segment carries fields for a segment number and an indication if this is the last segment. Based on these fields, UE (100) assembles the RRC message for SIBx and receives the security information for the system information protection/verification.

In an embodiment, UE (100) discards the received SIBx and/or stored segments of the SIBx in at least one the following event:
a) The UE (100) performs a cell reselection to a different cell where the UE (100) received the SIBx or stored SIBx segments (This is illustrated in FIG. 2);
b) The UE (100) transitions from one of RRC_IDLE and RRC_INACTIVE state to RRC_CONNECTED state;
c) The UE (100) receives an indication that system information is changed and/or valueTag is changed;
d) The UE (100) returns to the cell from out of coverage;
e) The UE (100) determines that the validity duration for the SIBx has expired;
f) After 3 hours from the moment stored version of SIBx was successfully confirmed as valid;

If the complete SIBx has not been assembled from the SIBx segment(s) within a period of 3 hours.

In an embodiment, when at least one of the aforementioned events a), c), d), e), f) and g) occurs, UE (100) accesses the SIBx or the segments of the SIBx again and verifies the at least one of the MIB, SIB1 and other SIB(s) using the security information in the SIBx.

In an embodiment, a structure for SIBx is provided. The example specification is illustrated as follows:

### Example: SIBx

| | |
|---|---|
| SIBx := | SEQUENCE { |
| digitalSignature-info | SEQUENCE (SIZE (1..maxNrofdigital-Signatures)) OF |

digitalSignature,

| | |
|---|---|
| validityDuration | ENUMERATED {t1, t2, t4, t8, t16, t32, t64, t128, t256, |

t512, infinity, spare5, spare4, spare3, spare2,

| | |
|---|---|
| | spare1} |
| digitalSignatureLength | ENUMERATED {256, 512, 1024}, |
| TCN-info | BIT STRING (SIZE (N)), |
| MIB-SFN-Info | BIT STRING (SIZE (6)), |

OPTIONAL, -- Need S

| | |
|---|---|
| lateNonCriticalExtension | OCTET STRING |

```
OPTIONAL,
      ...
  }
```

*validityDuration

The valid time duration for SIBx, time unit is one default paging cycle or some defined time period. The field is only valid while the UE (100) has a valid SIBx.

*digitalSignature-info

This field indicates a set of digital signature information. This may be one or more digital signature(s). If there are more than one digital signature, their applicability to respective SIBs is provided by an index field or order of the digital signature or by an explicit indication of SIB.

*digitalSignatureLength: This field indicates the length of digital signature (e.g. 512 bits)

*TCN-info: This field indicates the LSB of Time Counter (e.g. size is N bits)

*MIB-SFN-Info: This field indicates the 6 MSB of the 10-bit SFN, which corresponds to the MIB with which digital signature is computed.

In an embodiment, a structure for SIBx with segmentation is provided. The example specification is illustrated as follows:

### Example: SIBx with Segmentation

| | |
|---|---|
| SIBx := | SEQUENCE { |
| segmentNumber | INTEGER (0..63), |
| segmentType | ENUMERATED {notLastSegment, lastSegment}, |
| segmentContainer | OCTET STRING |

}

| | |
|---|---|
| SIBx-IEs := | SEQUENCE { |
| digitalSignature-info | SEQUENCE (SIZE (1..maxNrofdigital-Signatures)) OF |

digitalSignature,

| | |
|---|---|
| validityDuration | ENUMERATED {t1, t2, t4, t8, t16, t32, t64, t128, t256, |

t512, infinity, spare5, spare4, spare3, spare2,

| | |
|---|---|
| | spare1} |
| digitalSignatureLength | ENUMERATED {256, 512, 1024}, |
| TCN-info | BIT STRING (SIZE (N)), |
| MIB-SFN-Info | BIT STRING (SIZE (6)), |

OPTIONAL, -- Need S

| | |
|---|---|
| lateNonCriticalExtension | OCTET STRING |

```
OPTIONAL,
      ...
  }
```

*segmentContainer

This field includes a segment of the encoded SIBx-IEs. The size of the included segment in this container should be small enough that the SIB message size is less than or equal to the maximum size of a NR SI, i.e. 2976 bits when SIBx is broadcast.

*segmentNumber

This field identifies the sequence number of a segment of SIBx-IEs. A segment number of zero corresponds to the first segment, a segment number of one corresponds to the second segment, and so on.

*segmentType

This field indicates whether the included segment is the last segment or not.

*validityDuration

The valid time duration for SIBx, time unit is one default paging cycle or some defined time period. The field is only valid while the UE (100) has a valid SIBx.

*digitalSignature-info

This field indicates a set of digital signature information. This may be one or more digital signature(s). If there are more than one digital signature, their applicability to respective SIBs is provided by an index field or order of the digital signature or by an explicit indication of SIB.

*digitalSignatureLength

This field indicates the length of digital signature (e.g. 512 bits)

### *TCN-info

This field indicates the LSB of Time Counter (e.g. size is N bits)

### *MIB-SFN-Info

This field indicates the 6 MSB of the 10-bit SFN, which corresponds to the MIB with which digital signature is computed.

In an embodiment, SIBx with segmentation approach is used when the security information for authenticity verification of system information to be conveyed to the UE (100) exceeds 2976 bits which is the maximum size of the SIB.

In an embodiment, invention specifies UE (100)'s actions when receiving SIBx segments. The example specification text is illustrated as follows:

### Example

Upon receiving SIBx, the UE (100) shall:
1>if the UE (100) has stored at least one segment of SIBx and the value tag of SIBx has changed since a previous segment was stored:
2>discard all stored segments;
1>store the segment;
1>if all segments have been received:
2>assemble SIBx-IEs from the received segments.

In an embodiment, invention specifies the UE (100)'s actions when the security verification for at least one of MIB or SIB1 fails. The example specification text is illustrated as follows:

### Example

The UE (100) shall:
1>if in RRC_IDLE or in RRC_INACTIVE or in RRC_CONNECTED while T311 is running:
2>if the UE (100) is unable to acquire the MIB or security verification for MIB fails:
3>consider the cell as barred in accordance with TS 38.304;
3>perform barring as if intraFreqReselection is set to allowed;
2>else if the UE (100) is unable to acquire the SIB1 or security verification for SIB1 fails:
3>consider the cell as barred in accordance with TS 38.304;
3>if the UE (100) is a RedCap UE (100):
4>perform barring as if intraFreqReselectionRedCap is set to allowed;
3>else:
4>perform cell re-selection to other cells on the same frequency as the barred cell as specified in TS 38.304

In another embodiment, a new UE timer is configured or utilized to avoid accessing a cell when the system information security validation fails. The UE (100) starts the timer for the cell when the SI security verification fails and this timer may be maintained per cell. Upon expiry of the timer, the UE (100) may consider the cell for selection/reselection. Time duration can be configured by the network (510) (e.g. through RRC reconfiguration or NAS signaling) or fixed (e.g. pre-specified).

In an embodiment, minimum system information (i.e. MIB and SIB1) are utilized to compute the digital signature at the network (510) and verification of the received MIB and SIB1 at the UE (100). As MIB is transmitted with a periodicity of 80 ms and repetitions of the MIB are made within 80 ms. Similarly, SIB1 has periodicity of 160 ms and has a variable transmission periodicity within 160 ms. The default transmission repetition periodicity of SIB1 is 20 ms but the actual transmission repetition periodicity is up to network (510) implementation. For SSB and CORESET multiplexing pattern 1, SIB1 repetition transmission period is 20 ms. For SSB and CORESET multiplexing pattern 2/3, SIB1 transmission repetition period is the same as the SSB period. Given the stringent periodicity of MIB and SIB1, it is important to design the periodicity of the SIBx.

In an embodiment, periodicity of SIBx is fixed as periodicity X ms (e.g. 80 ms or 160 ms) so that UE (100) avails SIBx immediately after receiving SIB1 (or its repetition) and verify MIB and/or SIB1 quickly. In an alternative embodiment, it is set as a required performance condition for the UE (100) to verify the MIB and/or SIB1 with the security information received within the same 160 ms scheduling window. This is important to achieve the low latency performance and verifying essential system information quickly and also the SFN information in the SIBx corresponds to the specific MIB occasion. The advantage of fixing the periodicity of SIBx is to mitigate or identify the Man-in-the-Middle/person-in-the-middle attack, as the UE (100) will expect the security information in the scheduled period, if the security information is not present in the scheduled time, then UE (100) suspect the authenticity of the cell. If the periodicity of SIBx is not fixed, then the FBS acting as person-in-the-middle can pretend it does not support protection/verification of MIB and SIBs and remove the security information included by the genuine base-station, so that UE (100) will not verify the authenticity of the cell.

In an embodiment, delayed verification of the MIB and/or SIB1 is allowed. The SIBx security information is based on a previously broadcasted MIB and/or SIB1. When the UE (100) receives MIB and/or SIB1, UE (100) stores the MIB and/SIB1 and verifies the stored MIB and/or SIB1, when it receives the SIBx with the corresponding security information for the stored MIB and/or SIB1. The UE (100) can be informed about the relevant MIB and/or SIB1 by indicating the MSB of SFN information in the SIBx. In an alternative embodiment, when delayed verification of MIB and/or SIB1 is not acceptable (e.g. for enabling faster cell reselection), the UE (100) may skip the verification step.

In an embodiment, the periodicity for the SIBx is configured by the network (510) and can be set to one of the periodicities (which can be 80/160/320/640/1280/2560/5120 ms). The SIBx is mapped to a separate system information (SI) message or can be mapped together with other SIB(s) in an SI message.

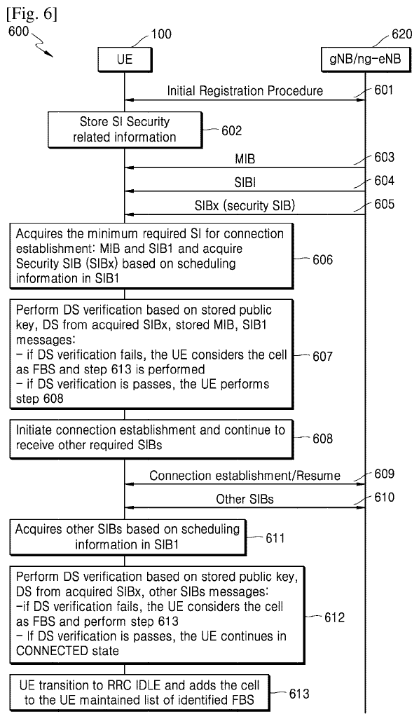

FIG. 6 is a sequence diagram (600) illustrating a scenario of procedural flow of the UE (100) to perform connection establishment and handling the system information validation, according to the embodiments as disclosed herein.

At step 601, the UE (100) initiates registration procedure with the gNB/ng-eNB (620). The registration procedure includes SI security capability, list of cells/TAs/RAs/supporting SI security, Public key for DS validation and the like.

At step 602, the UE (100) stores SI Security related information including list of SI security capable cells/Tas/Ras, Public key.

At step 603, 604 and 605, the UE (100) receives MIB, SIB1 and SIBx from the gNB/ng-eNB (620).

At step 606, the UE (100) acquires the minimum required SI for connection establishment: MIB and SIB1 and acquire Security SIB (SIBx) based on scheduling information in SIB1.

At step 607, the UE (100) performs DS verification based on stored public key, DS from acquired SIBx, stored MIB, SIB1 messages: when DS verification fails, the UE (100) considers the cell as FBS and step 613 is performed, when DS verification is passes, the UE (100) performs step 608.

At step 608, the UE (100) initiates connection establishment and continue to receive other required SIBs.

At step 609, the UE (100) performs connection establishment/Resume with the gNB/ng-eNB (620).

At step 610, the UE (100) communicates with the gNB/ng-eNB (620) to receive other SIBs.

At step 611, the UE (100) acquires the other SIBs based on scheduling information in SIB1.

At step 612, the UE (100) performs DS verification based on stored public key, DS from acquired SIBx, other SIBs messages: when the DS verification fails, the UE (100) considers the cell as FBS and perform step 613 or when DS verification is passes, the UE (100) continues in CONNECTED state.

At step 613, the UE (100) transition to RRC IDLE and adds the cell to the UE (100) maintained list of identified FBS.

In an embodiment, when the network provides the security information (Digital Signature) for the individual SIBs separately, and the UE (100) in RRC IDLE/INACTIVE state may initiate establishment/resumption of connection after acquiring and validating the required System information such as MIB, SIB1 needed for connection establishment and the security information carried in a separate SIB/SI message. The UE (100) may continue to acquire and validate other required SI messages after initiating the connection establishment procedure. If the validating of the other SI messages fail while the connection establishment is ongoing or the UE (100) already successfully transitioned to the RRC CONNECTED state, the UE (100) considers the current serving cell as a FBS.

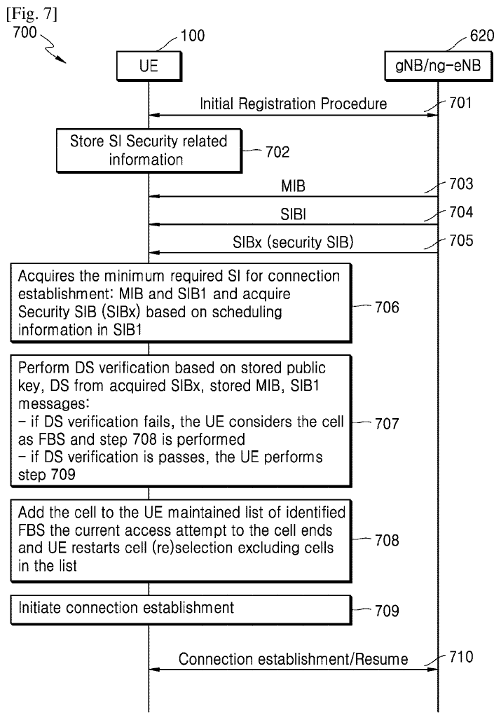

FIG. 7 is a sequence diagram illustrating a scenario of UE (100) handling SI validation of all SI messages, according to the embodiments as disclosed herein.

At step 701, the UE (100) performs initial Registration Procedure with the gNB/ng-eNB (620). The procedure includes transmission of SI security capability, list of cells/TAs/RAs supporting SI security and public key of DS validation.

At step 702, the UE (100) Stores SI Security related information including list of SI security capable cells/TAs/RAs, Public key.

At steps 703, 704 and 705, the UE (100) receives MIB, SIB1 and SIBx from the gNB/ng-eNB (620).

At step 706, the UE (100) acquires the minimum required SI for connection establishment: MIB and SIB1 and acquire Security SIB (SIBx) based on scheduling information in SIB1.

At step 707, the UE (100) Performs DS verification based on stored public key, DS from acquired SIBx, stored MIB, SIB1 messages: when DS verification fails, the UE (100) considers the cell as FBS and step 708 is performed, when DS verification is passes, the UE (100) performs step 709.

At step 708, the UE (100) adds the cell to the UE (100) maintained list of identified FBS the current access attempt to the cell ends and UE (100) restarts cell (re)selection excluding cells in the list.

At step 709, the UE (100) initiates connection establishment with the gNB/ng-eNB (620).

At step 710, the UE (100) performs connection establishment/Resume with the gNB/ng-eNB (620).

In an embodiment, the UE (100) initiates the connection establishment/resumption only after validating all the required SI. If the SI validation using the received security information fails, the UE (100) considers the cell it is attempting to connect to, is the FBS.

In an embodiment, the UE (100) maintains a list of cells, which are considered as FBS. The UE (100) adds a cell to the list (e.g. a blocked cell list or a black cell list) when the Security validation of the System Information message fails for the cells. The UE (100) does not try to access/establish connection to the cells in this list.

During the initial registration process with the Core Network (CN), the UE (100) is provisioned with the list of public key to be used to validate the Digital Signature of the System Information. The CN may also configures where the System Information Security is applied/supported, comprising at least one of the following:
a list of cells
a list of frequencies
a list of Tracking Area/Registration Area
Indication of homogeneous application throughout all cells of the PLMN.
The UE (100) identifies that the network does not support SI Security:
Implicitly based on the Scheduling Information broadcasted on SIB1, if the SIB1 does not schedule SIBx (SIB carrying the Security information/Digital Signature)
Explicitly based on an indication/bitmap/bit flag in SIB1, indicating the support of SI security in the cell

In an embodiment, if the cell ID/TA/RA or PLMN broadcasted by the cell in SIB1 is part of the CN configured list of cells/TA/RA or PLMN mandating support of SI security and the UE (100) determines that the cell does not support SI security, the UE (100) considers the cell as FBS ands it to the encountered FBS cell list.

In another embodiment, the UE (100) maintains a timer per element/cell in the encountered FBS list. The UE (100) starts the timer associated with the cell when it adds the cell to the encountered FBS list. When the timer expires, the UE (100) removes the cell from the encountered FBS list. The timer value is configured by the network during the initial registration process. The network signals the timer value to be used as part of at least one of a NAS message (such as Registration accept message), RRCReconfiguration message, and RRCRelease message. Alternatively, the UE (100) uses a predefined default timer value or an implementation specific timer value.

In an embodiment, when the cell is determined to be a FBS based on the SI validation check done by the UE (100), the UE (100) considers the frequency the cell is operating in as lowest priority for cell reselection. The UE (100) maintains the list of FBS frequencies to deprioritize and added to the list a frequency of the cell which it determines to be a FBS based on SI security check. In an embodiment, the UE (100) maintains a timer per frequency it adds to the list of FBS frequencies to deprioritize. The UE (100) uses a timer value through at least one of configured value through a NAS message such as Registration accept message, RRC signaling such as RRCReconfiguration message, RRCRelease message, a pre-defined default value or implementation specific timer value.

Alternatively, in another embodiment, when the UE (100) identifies a cell to be the FBS, it performs at least one of the following:
Barring of cell (for a predefined or configured duration)
Not considering the cell (no duration applies)
Barring of frequency (for a predefined or configured duration)
Not considering the frequency (no duration applies)
de-prioritize the cell (for a predefined or configured duration)

In another embodiment, the UE (100) does not verify the validity of all the SI messages broadcasted by the network but only checks the Digital Signature of the SIBs the UE (100) require. It can happen that the FBS modifies/tampers SIBs that the UE (100) has not checked. In such a case, the UE (100) might wrongly camp on to the FBS and continue operating. The network can still get to know the network node is a FBS based on the reporting from other UEs, which verified the tampered SIBs. The network can signal to release connections of the UEs still attached to the FBS by providing an RRCRelease message or a NAS based release. The release message may also contain indication that the previously connected cell was a FBS and/or an indication to not attempt access to the last connected cell.

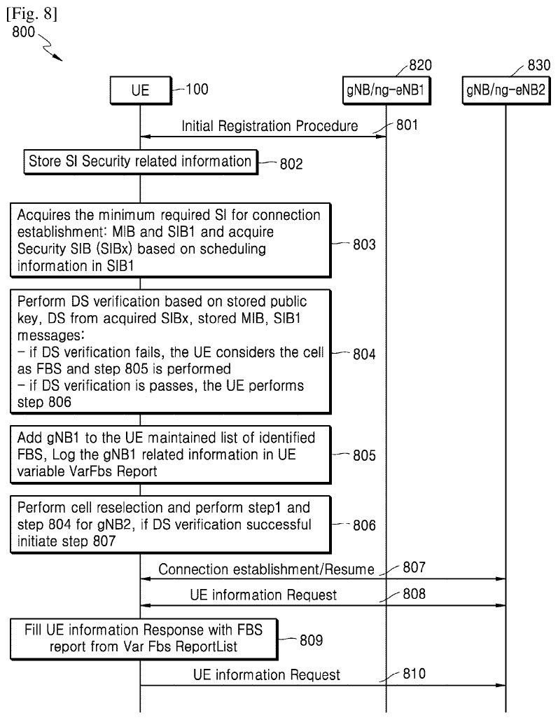

FIG. 8 is a sequence diagram illustrating a scenario of signaling between gNB and UE (100) to perform logging and FBS related reporting, according to the embodiments as disclosed herein.

At step 801, the UE (100) performs initial registration procedure with the gNB/ng-eNB1 (820), the registration procedure includes SI security capability, list of cells/TAs/RAs supporting SI security, public key of DS validation, capability related to logging and reporting FBS related info.

At step 802, the UE (100) stores SI Security related information including list of SI security capable cells/TAs/RAs, Public key.

At step 803, the UE (100) acquires the minimum required SI for connection establishment: MIB and SIB1 and acquire Security SIB (SIBx) based on scheduling information in SIB1.

At step 804, the UE (100) performs DS verification based on stored public key, DS from acquired SIBx, stored MIB, SIB1 messages: when DS verification fails, the UE (100) considers the cell as FBS and step 805 is performed, and when the DS verification is passes, the UE (100) performs step 806.

At step 805, the UE (100) adds gNB1 to the UE (100) maintained list of identified FBS, Log the gNB1 related information in UE (100) variable VarFbs Report. The VarFbs report includes, but not limited to, PCI, freq info, location info, failure type.

At step 806, the UE (100) performs cell reselection and perform step1 and step 804 for gNB2, if DS verification successful initiate step 807.

At step 807, the UE (100) performs Connection establishment/Resume with the gNB/ng-eNB2 (830). The UE (100) indicate FBS report availability in RRCSetupComplete/RRC Resume complete.

At step 808, the UE (100) receives UE information Request including Fbs reportReq from the gNB/ng-eNB2 (830).

At step 809, the UE (100) fills UE information Response with FBS report from Var Fbs ReportList.

At step 810, the UE (100) transmits UE information Request including Fbs reportlist to the gNB/ng-eNB2 (830).

In an embodiment, the network can understand the mode of attack or the information on what the attacker is intending to do based on the information collected at the UE (100). In an embodiment, the UE (100) signals its capability to store logged information regarding the identified FBSs as part of the UE (100) capability exchange procedure during the initial registration process with the Core Network (CN). If the UE (100) supports logging the FBS related information, the CN, along with SI security related configuration configures the UE (100) to store the information regarding the identified FBSs.

In an embodiment, the UE (100) stores at least one of or combination of the following information regarding the identified FBS:
fbsPhyCellId: Cell ID of the FBS
fbsCarrierFreqNR: The ARFCN of the frequency in which the FBS is operating
fbsPLMN-Id: The PLMN ID the UE (100) was trying to access
List of timestamps when the UE (100) tried to access the FBS
locationInformation: Location Information where UE (100) encountered the FBS
failureType: Indicates the cause of FBS detection. It can be due to:
SISecurityUnavailable: unavailability of SI security in a cell which is configured to mandatorily support SI security,
SiCheckFailed: Digital Signature validation fails for System Information
failedSImessage: The stored SI message/messages, which failed the validation against the received Digital Signature. The UE (100) stores the failed SI messages when configured by network to do so.

The logged FBS information are store in a UE variable VarFBSReportList consisting of list of VarFBSReport. When the UEInformationRequest message indicating to send FBS report is received by the UE (100), it uses the stored VarFBSReport to fill UEInformationResponse. UE sends the UEInformationResponse message to the network.

The following is a sample ASN structure depicting the UE Variable to store the list of encountered FBS s.

VarFBSReport:= SEQUENCE {

| | |
|---|---|
| fbsReport | FbsReport, |

| | |
|---|---|
| nonCriticalExtension | SEQUENCE{ } OPTIONAL |

```
  }
  FbsReport := SEQUENCE {
```

| | |
|---|---|
| fbsPhyCellId | PhysCellId, |
| fbsCarrierFreqNR | ARFCN-ValueNR, |

fbsPLMN-IdPLMN-Identity,

| | | |
|---|---|---|
| failureType | ENUMERATED( | SiCheckFailed , |

SISecurityUnavailable)

| | |
|---|---|
| locationInformation | CommonLocationInfo-r16OPTIONAL, |

```
  }
  VarFBSReportList:= SEQUENCE {
```

| | |
|---|---|
| fbsReportList | SEQUENCE(SIZE(1..maxFBSReport)) OF VarFBSReport |

}

In an embodiment, the UE (100) when establishing a connection/resuming the connection to a valid Base Station, if previously configured to log identified FBS information, and has a valid FBS logged information, indicates to the network through at least one of RRC signaling or NAS based signaling that it has logged FBS information available.

The following is a sample specification text change in 38.331 to indicate availability of FBS report in RRCSetupComplete:

The UE (100) shall perform the following actions upon reception of the RRCSetup:

### <Unchanged Text Omitted>

1> set the content of RRCSetupComplete message as follows:

### <Unchanged Text Omitted>

2>if the UE (100) is configured to log FBS related information and has logged FBS related reports available for NR:
3>include the fbsReportAvailable;

Sample ASN of RRCSetupComplete including indication for availability of FBS report.

| | |
|---|---|
| RRCSetupComplete-v1800-IEs := | SEQUENCE { |
| fbsReportAvailable | ENUMERATED {true} |
| OPTIONAL, nonCriticalExtension | SEQUENCE{ } |

OPTIONAL
}

In an embodiment, when the UE (100) indicates that it has stored information of FBSs, the network requests the UE (100) through UEInformationRequest message or a new RRC message to send the FBS related report.

In an embodiment, upon receiving the FBS report request from network through UEInformationRequest message, the UE (100) prepares the FBS report and sends it as part of UEInformationResponse message. The following is the changes in the specification text to handle sending of UEInformationReponse message:

### <Unchanged Text Omitted>

1>iffbsReportReq is set to true and the UE (100) has encountered FBSs and has FBS related information in VarFBSReportList:
2>for each fbsReport in the fbsReportList in the UEInformationResponse message, set the value to the value of fbsReport in VarFBSReportin VarFBSReportList;
2>discard the fbsReport from VarFBSReportList upon successful delivery of the UEInformationResponse message confirmed by lower layers.

The following is a sample ASN structure of UEInformationRequest including indication for requesting FBS report:

UEInformationResponse-v1800-IEs := SEQUENCE {
fbsReportList FbsReportList OPTIONAL,
nonCriticalExtension SEQUENCE { } OPTIONAL
}

FbsReportList:=SEQUENCE (SIZE (1 . . . maxFbsReport)) OF FbsReport

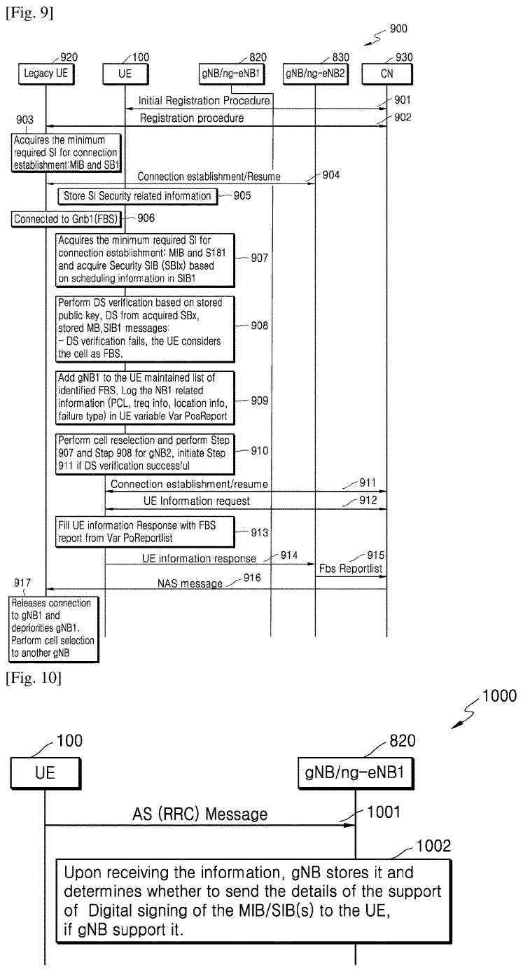

FIG. 9 is a sequence diagram illustrating a scenario of signalling from Core Network to release a legacy UE connected to the FBS, according to the embodiments as disclosed herein.

At step 901, the UE (100) performs initial registration procedure with a core network (9300), the registration procedure includes SI security capability, list of cells/TAs/RAs supporting SI security, public key of DS validation, capability related to logging and reporting FBS related info.

At step 902, the legacy UE (920) performs registration procedure with the core.

At step 903, the legacy UE (920) acquires the minimum required SI for connection establishment: MIB and SIB1.

At 904, the legacy UE and core network performs connection establishment or resume the connection with the gNB/ng-eNB2 (830).

At step 905, the UE (100) stores SI Security related information including list of SI security capable cells/TAs/RAs, Public key.

At step 906, the UE (100) is connected to Gnb1 (FBS).

At step 907, the UE (100) acquires the minimum required SI for connection establishment: MIB and SIB1 and acquire Security SIB (SIBx) based on scheduling information in SIB1.

At step 908, the UE (100) performs DS verification based on stored public key, DS from acquired SIBx, stored MB, SIB1 messages: DS verification fails, the UE (100) considers the cell as FBS.

At step 909, the UE (100) adds gNB1 to the UE (100) maintained list of identified FBS, Log the NB1 related information (PCL, treq info, location info, failure type) in UE (100) variable Var PosReport.

At step 910, the UE (100) performs cell reselection and perform Step 907 and Step 908 for gNB2, initiate Step 911 if DS verification successful

At step 911, the UE (100) and core network perform connection establishment or resume the connection with the gNB/ng-eNB2 (830).

At step 912, the UE (100) receives UE Information request from the gNB/ng-eNB2 (830).

At step 913, the UE (100) fills UE information Response with FBS report from Var PoReportlist.

At step 914, the UE (100) transmits UE information response to the gNB/ng-eNB2 (830).

At step 915, the gNB/ng-eNB2 (830) transmits the Fbs Reportlist to the core (930).

At step 916, the core (930) sends a NAS message to the legacy UE (920)

At step 917, the legacy UE (920) releases connection to gNB1 and deprioritise gNB1. Perform cell selection to another gNB.

In an embodiment, the legacy UEs and/or UEs without the capability to perform SI security verification can still connect to a FBS as they do not have a way to verify the authenticity of the gNB. In a network consisting of UEs supporting FBS identification and legacy UEs, the network can get to know the existence of a FBS based on the reporting from the UEs capable of identifying FBSs. The genuine gNB then reports to the Core Network the list of identified FBSs obtained from the logged reports of the UEs. If the CN identifies legacy UEs are connected to the FBS, the CN initiates a protected NAS message to the UEs connected to the FBS consisting of at least one of:
Indication of a connection release
Indication to deprioritize/block/bar the current cell
timer information till which the deprioritization/barring applies

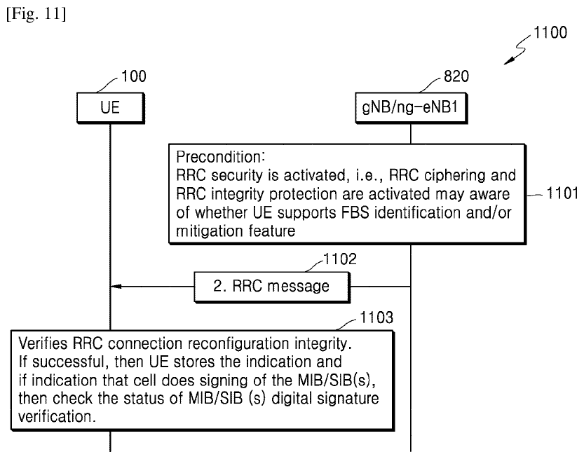

FIG. 10 is a sequence diagram (1000) illustrating signalling of the support for FBS identification and mitigation, according to an embodiment as disclosed herein.

At step 1001, the UE (100) sends a RRC message to the gNB/ng-eNB1 (820). The RRC message includes parameters, indication of Digital signature verification support.

At step 1002, the gNB/ng-eNB1 (820) upon receiving the information, gNB stores it and determines whether to send the details of the support of Digital signing of the MIB/SIB(s) to the UE (100), if gNB support it.

In an embodiment herein, if the UE (100) and the gNB supports FBS identification and mitigation as a mandatory feature (for example, all UEs and gNBs supports from Rel-18), then based on the UE (100) capability parameter on the access stratum release (“accessStratumRelease”), the gNB knows whether the UE (100) supports FBS identification and mitigation feature or not.

In an embodiment herein, the UE (100) includes the indication of support for FBS identification and mitigation feature capability as an explicit parameter in the AS procedure. For example, the AS procedures being: UE (100) capability exchange or SMC procedure (AS Security Mode Complete message) or RRC Connection establishment procedure (may be RRCReconfigurationComplete or part of UE (100) Radio Capability Update or an independent new parameter).

In an embodiment herein, upon receiving the capability of the UE (100), if the network (RAN) also supports the capability, then the gNB stores the UE (100)'s capability (may be as part of UE (100) security context) and determines whether to send the details of the support of Digital signing of the MIB/SIB(s) to the UE (100).

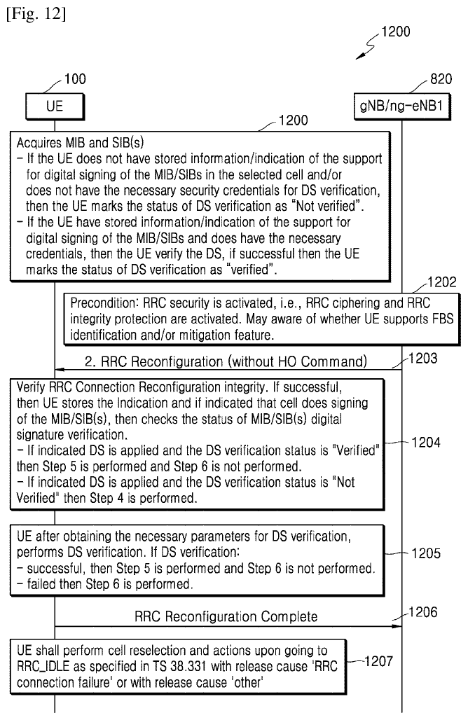

FIG. 11 is a sequence diagram (1100) illustrating signalling of the support for FBS identification and mitigation using a RRC message, according to an embodiment as disclosed herein.

At step 1101, gNB/ng-eNB1 (820) verifies with preconditions including RRC security is activated, that is RRC ciphering and RRC integrity protection are activated may aware of whether UE (100) supports FBS identification and/or mitigation feature.

At step 1102, the gNB/ng-eNB1 (820) sends a RRC message to the gNB/ng-eNB1 (820). The RRC message includes other possible parameters, indication of digital signing of MIB/SIB(s) in the list of cell IDs and/or RAN Area IDs and/or Tracking Area IDs and/or PLMN ID.

At step 1103, the UE (100) Verifies RRC connection reconfiguration integrity. If successful, then UE (100) stores the indication and if indication that cell does signing of the MIB/SIB(s), then check the status of MIB/SIB (s) digital signature verification.

In an embodiment herein, the gNB indicates its capability to the UE (100) in the AS (RRC) message, which is protected (Integrity protected and/or confidentiality protected (encryption)). For example, the AS procedures being: Registration procedure (may be using RRC Connection Reconfiguration Message) or SMC procedure (AS Security Mode Command message) or in the System Information Block (SIB) broadcast. Upon receiving the protected RRC message from the gNB, the UE (100) verify the RRCReconfiguration message (for example, integrity and confidentiality). If verification is successful, then the UE (100) stores the indication/information. If indicated/informed that the camped cell does signing of the MIB/SIB(s), then the UE (100) checks the status of MIB/SIB(s) digital signature verification.

In an embodiment, the gNB provides indication/information that Digital Signing of MIB/SIB(s) are supported for the list of cell IDs (NR Cell Global Identities (NCGIs) or NR Cell Identities (NCIs)) and/or RAN-based Notification Area (RNA) cell IDs and/or Tracking Area IDs and/or PLMN IDs.

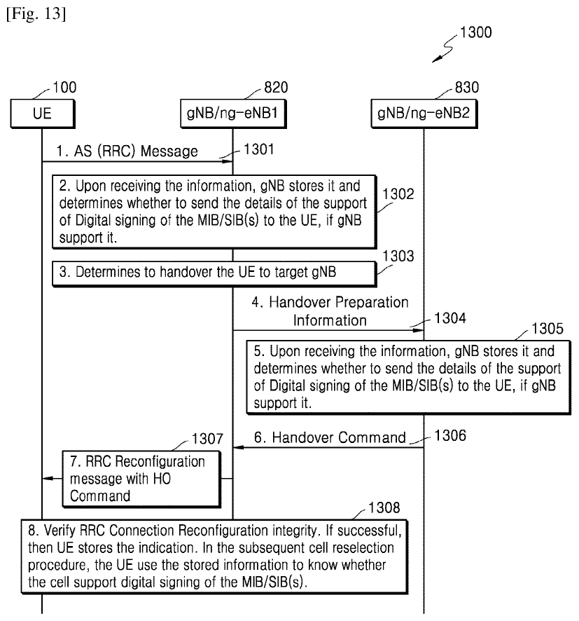

FIG. 12 is a sequence diagram illustrating signalling of the support for FBS identification/mitigation and verify the authenticity of the selected cell, according to an embodiment as disclosed herein.

At step 1201, the UE (100) acquires MIB and SIB(s). If the UE (100) identifies that DS is included in the acquired System Information (in any of the SIB), then if the UE (100) does not have stored information/indication of the support for digital signing of the MIB/SIBs in the selected/camped cell and/or does not have the necessary security credentials for DS verification, then the UE (100) marks the status of DS verification as “Not Verified”. If the UE (100) have stored information/indication of the support for digital signing of the MIB/SIBs and does have the necessary credentials, then the UE (100) verify the DS, if successful then the UE (100) marks the status of DS verification as “Verified”. If the UE (100) identifies that DS is not included in the acquired System Information (in any of the SIB), then the UE (100) marks the status of DS verification as “Not Verified”.

At step 1202, The UE (100) and gNB follows the legacy Registration procedure and activates RRC security (protection of RRC messages).

At step 1203, The gNB indicates its capability to the UE (100) in the AS (RRC) message, which is protected (Integrity protected and/or confidentiality protected (encryption)). For example, the AS procedures being: Registration procedure (may be using RRC Connection Reconfiguration Message) or SMC procedure (AS Security Mode Command message) or in the System Information Block (SIB) broadcast. Upon receiving the protected RRC message from the gNB, the UE (100) verify the RRCReconfiguration message (for example, integrity and confidentiality). If verification is successful, then the UE (100) stores the indication/information. If indicated/informed that the camped cell does signing of the MIB/SIB(s), then the UE (100) checks the status of MIB/SIB(s) digital signature verification.

In an embodiment, the gNB provides indication/information that Digital Signing of MIB/SIB(s) are supported for the list of cell IDs (NR Cell Global Identities (NCGIs) or NR Cell Identities (NCIs)) and/or RAN-based Notification Area (RNA) cell IDs and/or Tracking Area IDs and/or PLMN IDs.

At step 1204, upon receiving the protected RRC message from the gNB, the UE (100) verifies the RRCReconfiguration message (for example, integrity and confidentiality). If verification is successful, then the UE (100) stores the indication/information. If indicated/informed that the camped cell does signing of the MIB/SIB(s), then the UE (100) checks the status of MIB/SIB(s) digital signature verification. If indicated DS is applied and the DS verification status is “Verified” then Step 5 is performed and Step 6 is not performed. If indicated DS is applied and the DS verification status is “Not Verified” then Step 4 is performed.

At step 1205, the UE (100) after obtaining the necessary parameters for DS verification performs DS verification. If DS verification,
is successful, then Step 5 is performed and Step 6 is not performed.
failed then Step 6 is performed.

At 1206, the UE (100) send the RRC Reconfiguration Complete message to the gNB, as specified in TS 38.331.

At 1207, the UE (100) shall perform cell reselection (moved to idle mode) and actions upon going to RRC_IDLE as per conventional methods.

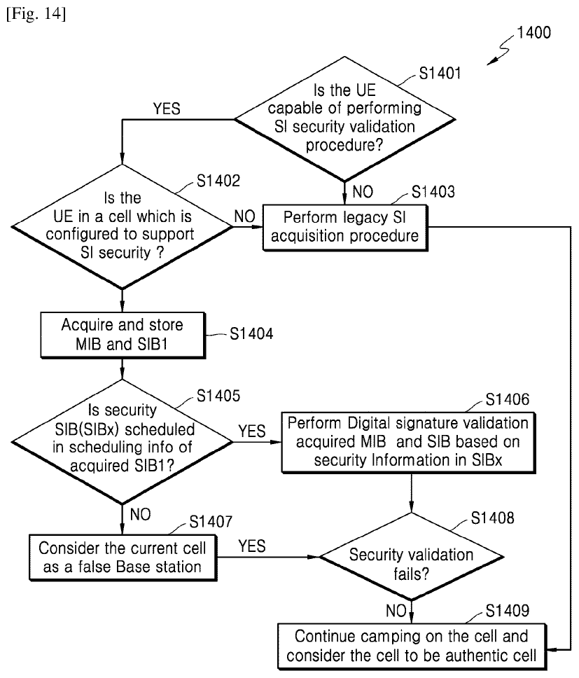

FIG. 13 is a sequence diagram (1300) illustrating signalling of the support for FBS identification and mitigation to know the information of other cells, according to an embodiment as disclosed herein.

At step 1301, the UE (100) includes the indication of support for FBS identification and mitigation feature capability as an explicit parameter in the AS procedure. For example, the AS procedures being: UE (100) capability exchange or SMC procedure (AS Security Mode Complete message) or RRC Connection establishment procedure (may be RRCReconfigurationComplete or part of UE (100) Radio Capability Update or an independent new parameter).

At step 1302, upon receiving the information, gNB stores it and determines whether to send the details of the support of Digital signing of the MIB/SIB(s) to the UE (100), if gNB support it.

At step 1303, at later point of time, when the serving/source gNB that is referred as gNB/ng-eNB1 (820) of the UE (100), determines to handover the UE (100) to target gNB that is referred as gNB/ng-eNB2 (830) (Normal Handover Procedure).

At step 1304, the source gNB sends the Handover Preparation Information message to the target gNB(s). The Handover Preparation Information message other possible parameters and indication of Digital Signature verification support of the UE (100).

At step 1305, upon receiving the information, target gNB stores it and determines whether to send the details of the support of Digital signing of the MIB/SIB(s) to the UE (100), if gNB support it.

At step 1306, if the target gNB agrees to take the UE (100), then the target gNB send the Handover command to the source UE (100) (normal procedure).

At step 1307, the source gNB sends the protected RRCReconfiguration message with HO Command (Other possible parameters, indication of Digital Signing of MIB/SIB(s) in the list of cell IDs and/or RAN Area IDs and/or Tracking Area IDs and/or PLMN ID) to the UE (100).

At step 1308, upon receiving the protected RRC message from the gNB, the UE (100) verify the RRCReconfiguration message (for example, integrity and confidentiality). If verification is successful, then the UE (100) stores the indication. In the subsequent cell reselection procedure, the UE (100) use the stored information to know whether the cell support digital signing of the MIB/SIB(s).

In another embodiment, the UE (100) is configured with the list of cells IDs and/or RAN Area IDs and/or Tracking Area IDs and/or PLMN ID) where the System Information Security is mandatory. When a UE (100) is trying to access a cell belonging to that configured list, and the MIB/SIB1 does not indicate the support of SI security in the cell either explicitly through an broadcasted indication in SIB1 or implicitly by not scheduling SIB/SI message carrying the Security information, the UE (100) considers the cell to be a FSB and stops the access attempt.

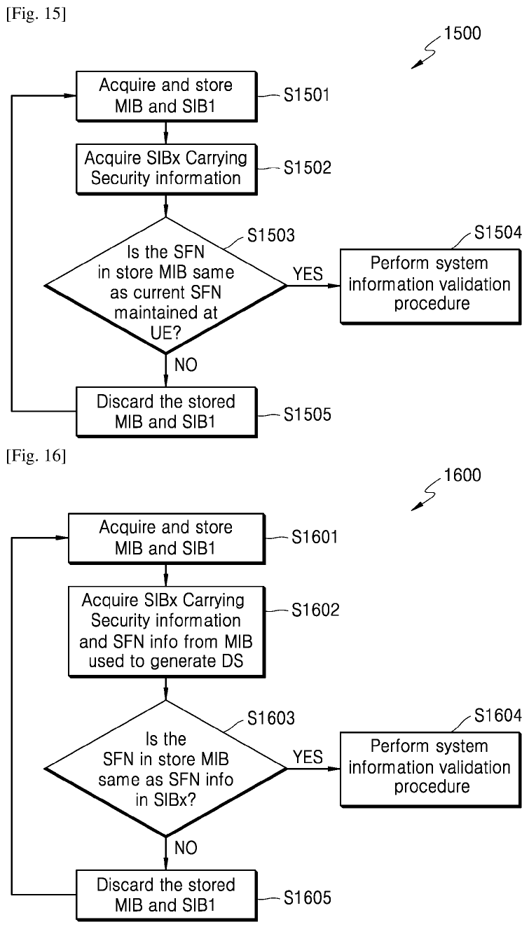

FIG. 14 is a flow diagram (1400) illustrating an operational flow for verifying the system information received on the serving cell for authenticity and replay protection/verification, according to an embodiment as disclosed herein.

At step S1401, the UE (100) determines whether the UE (100) is capable of performing SI security validation procedure,

At step S1402, the UE (100) determines whether the UE (100) in a cell which is configured to support SI security when the UE (100) is capable of performing SI security validation procedure.

At step S1403, the UE (100) performs legacy SI acquisition procedure when the UE (100) in the cell which is not configured to support SI security and perform step S1409.

At step S1404, the UE (100) acquires and stores MIB and SIB1 when the UE (100) is capable of performing SI security validation procedure.

At step S1405, the UE (100) determines whether the security SIB scheduled in scheduling info of acquired SIB1.

At step S1406, the UE (100) performs Digital signature validation of acquired MIB and SIB based on security Information in SIBx when the security SIB scheduled in scheduling info of acquired SIB1 and then perform step S1408.

At step S1407, the UE (100) considers the current cell as a false Base station when the security SIB is not scheduled in scheduling info of acquired SIB1.

At step S1408, the UE (100) performs security validation.

At step S1409, the UE (100) continues camping on the cell and consider the cell to be authentic cell when the security validation not fails.

In an embodiment, the network broadcasts the digital signature in a new System Information Block (SIB) message. The Digital signature broadcasted in the new SIB is generated based on at least one of or combination of:
Contents of system information messages (MIB, SIB1 and other SIB messages),
Timing related information (time of broadcasting and/or time of encoding of the SI message),
Frequency of operation of the base station,
gNB/Cell/Area identity and
Public and/or private key of the gNB/Cell/Area.

In an example scenario, the UE (100) acquires the MIB and cannot complete the acquisition of relevant SIB 1 and/or the SIB, carrying the associated security information, before the contents of the MIB changes due to change in SFN information in the MIB. The Digital signature (DS) is generated based on content of the entire MIB structure including SFN information and in the above mentioned case where DS SIB is acquired after the MIB has changed, the DS validation of the MIB will fail as the stored version of MIB in UE (100) would be different from the version of MIB used to generate the digital signature.

In an embodiment, the network generates separate DS for MIB, SIB1 and other SIBs based on the contents of the respective messages. The network signals the individual DSs in a common SIB or separate SIBs. The Digital Signature can be generated based on a single SIB or a combination of SIBs. The network signals the list of SIBs used to generate the Digital Signature as part of the SIB carrying the security information or the SI message container, which contains the security information. This list can be provides as:
A bitmap where each position in the bitmap indicates a SIB type and when the position in the bitmap is set to 1, indicates that the corresponding SIB is used in the generation of the Digital Signature
A list of index, where each index corresponds to the index of the scheduled SIB.

When the DSs of MIB is separate from SIB1 and other SIBs, the UE (100) does not have to read the DS SIB again when the MIB changes due to SFN information change, causing the DS of MIB to also change. In an embodiment, the SIB1 and/or DS SIB carries a flag indicating if the DS related to MIB is changed due to SFN change. The UE (100) acquires the SIB1 and if the change flag in the SIB1 indicates that DS SIB change is due to change in SFN of MIB, if the UE (100) already has a validated MIB, it does not perform validation of MIB again.

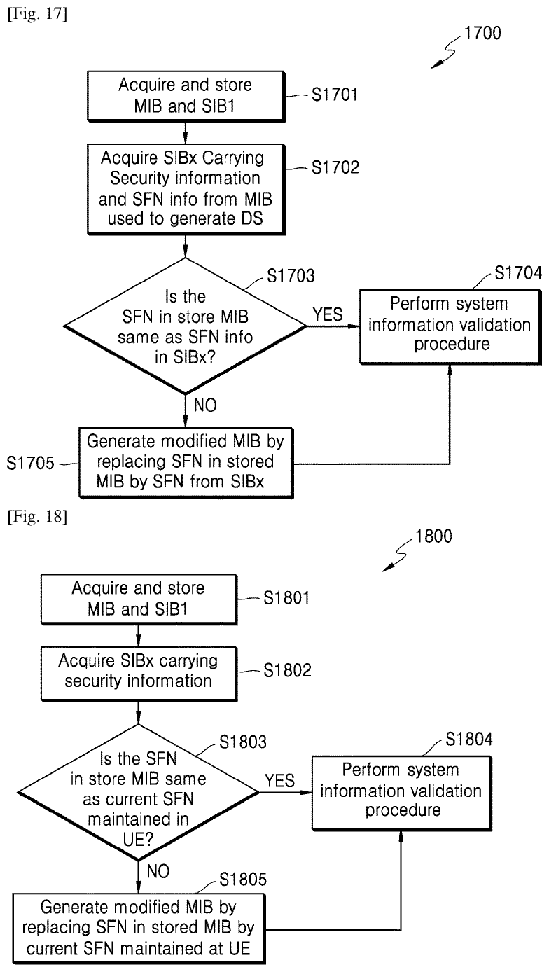

FIG. 15 is a flow diagram (1500) illustrating a method to avoid the SFN mismatch of the MIB and an acquired DS, according to an embodiment as disclosed herein.

At step 1501, the UE (100) acquires and store MIB and SIB1.

At step 1502, the UE (100) acquires SIBx Carrying Security information.

At step 1503, the UE (100) determines whether the SFN in store MIB same as current SFN maintained at the UE (100).

At step 1504, the UE (100) performs system information validation procedure when the SFN in store MIB same as current SFN maintained at the UE (100).

At step 1505, the UE (100) discards the stored MIB and SIB1 when the SFN in store MIB is not same as current SFN maintained at the UE (100).

In an embodiment, to avoid the SFN mismatch of the MIB message and the acquired DS, the network schedules the SIB1 and SIB carrying DS within the period before MIB change occurs due to SFN information change. The UE (100) acquires the SIB1 and DS SIB before the MIB content changes. If the UE (100) is not able to acquire the SIB1 and DS SIB before the MIB content changes, the UE (100) discards the acquired/stored MIB and initiates the acquisition of MIB in this new MIB transmission period.

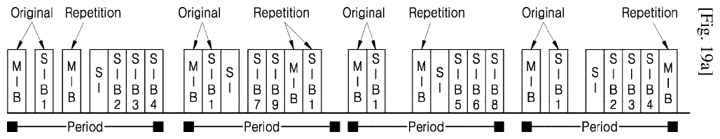

FIG. 16 is a flow diagram (1600) illustrating a method for matching SIB with the SFN in the stored MIB, according to an embodiment as disclosed herein.

At step 1601, the UE (100) acquires and stores MIB and SIB1

At step 1602, the UE (100) acquires SIBx Carrying Security information and SFN info from MIB used to generate DS.

At step 1603, the UE (100) determines whether the SFN in store MIB same as SFN info in SIBx.

At step 1604, the UE (100) performs system information validation procedure when the SFN in store MIB same as SFN info in SIBx.

At step 1605, the UE (100) discards the stored MIB and SIB1 when the SFN in store MIB is not same as SFN info in SIBx.

In an embodiment, when the Digital signature validation fails for a cell, the UE (100) may consider the cell to be a false base station and will avoid establishing connection to it for a specific time. In the event of DS validation failure caused due to mismatch between the store MIB and the DS being generated using the MIB after SFN change, the UE (100) will still identify the network as a false base station. In an embodiment, in order to avoid the case of determining a genuine base station as a false base station due to change in DS caused by change in SFN in MIB, the network signals the SFN value from MIB, which is used to generate the Digital signature, in the SIB carrying the Digital Signature. The UE (100) acquires the Security SIB, and verifies if the SFN parameter in the security SIB is same as the SFN information from the stored MIB. If there is a mismatch in the information, the UE (100) tries to acquire the MIB again and the corresponding security SIB. If the SFN in security SIB matches with the SFN in the stored MIB, the UE (100) proceeds to perform the System Information validation based on the stored messages (MIB, SIB1 and other SIBs) and the Digital signature in the security SIB.

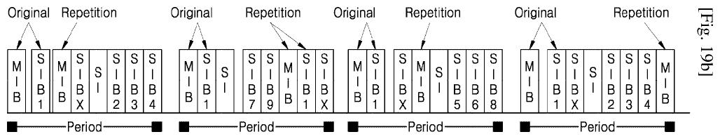

FIG. 17 is a flow diagram (1700) illustrating a method of validation of SIB by generating a version of modified MIB, according to an embodiment as disclosed herein.

At step 1701, the UE (100) acquires and stores MIB and SIB1.

At step 1702, the UE (100) acquires SIBx Carrying Security information and SFN info from MIB used to generate DS.

At step 1703, the UE (100) determines whether the SFN in store MIB same as SFN info in SIBx.

At step 1704, the UE (100) performs system information validation procedure when the SFN in store MIB same as SFN info in SIBx.

At step 1705, the UE (100) generates modified MIB by replacing SFN in stored MIB by SFN from SIBx when the SFN in store MIB is not same as SFN info in SIBx.

In an alternate embodiment, the UE (100) when validating the MIB, generates a version of modified MIB by updating the SFN information using SFN information present in DS SIB.

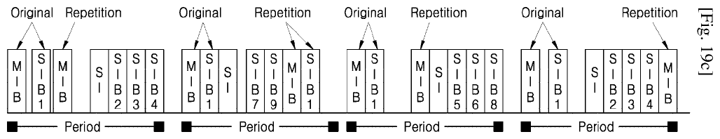

FIG. 18 is a flow diagram illustrating the modified MIB used for validation of MIB by replacing the SFN information when the network does not signal the SFN information, according to an embodiment as disclosed herein.

At step 1801, the UE (100) acquires and stores MIB and SIB1.

At step 1802, the UE (100) acquires SIBx carrying security information.

At step 1803, the UE (100) determines whether the SFN in store MIB same as current SFN maintained in UE (100).

At step 1804, the UE (100) performs system information validation procedure when the SFN in store MIB same as current SFN maintained in UE (100).

At step 1805, the UE (100) generates modified MIB by replacing SFN in stored MIB by current SFN maintained at UE (100) when the SFN in store MIB is not same as current SFN maintained in UE (100).

In another embodiment, if the network does not signal the SFN information in the DS SIB, the UE (100) generates the modified MIB used for validation of MIB by replacing the SFN information of the store MIB to the MSB 6 bits of the current SFN value maintained at UE (100).

| | |
|---|---|
| SIBx := | SEQUENCE { |
| securityInfo | SEQUENCE (SIZE (1..maxNrofdigital-Signatures)) OF |

digitalSignatureInfo,

| | |
|---|---|
| validityDuration | ENUMERATED {t1, t2, t4, t8, t16, t32, t64, t128, t256, t512, |

infinity, spare5, spare4, spare3, spare2, spare1}

| | |
|---|---|
| MIB-SFN-Info | BIT STRING (SIZE (6)), |

OPTIONAL, -- Need S

| | |
|---|---|
| lateNonCriticalExtension | OCTET STRING |

```
    OPTIONAL,
  ...
  }
```

| | |
|---|---|
| digitalSignatureInfo | := SEQUENCE{ |

sibType

| | |
|---|---|
| digitalSignature | OCTET STRING (SIZE |

(maxDigitalSigSize))
}

Security Info: This field indicates a set of digital signature information. This may be one or more digital signature(s). If there are more than one digital signature, their applicability to respective SIBs is provided by an index field or order of the digital signature or by an explicit indication of SIB.

MIB-SFN-Info: This field indicates the 6 MSB of the 10-bit SFN, which corresponds to the SFN information in MIB with which digital signature is computed.

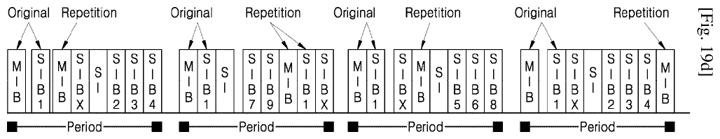

FIG. 19a is schematic diagram illustrating scheduling of MIB, SIB1 and other SIBs in a SI message, according to a prior art.

In an embodiment, since the SFN information element in the MIB is frequently changing, the network generates the Digital signature based on the contents of the MIB other than SFN (i.e. SSB Subcarrier Spacing, subcarrier Offset, DMRS position, SIB1 PDCCH configuration, cell barring information, flag to allow intra-frequency cell reselection). Alternatively, the network generates a modified MIB message by setting the SFN value to a constant value (such as 0) and use this modified MIB message to generate the Digital Signature. The network broadcasts the original MIB (with actual SFN value) and the DS generated by using modified MIB. This avoids the frequent changing of DS as the SFN value in MIB will not affect the DS generation.

FIG. 19b is schematic diagram illustrating the signaling of security information of MIB, SIB1 and other SIBs as part of SIBx, according to an embodiment as disclosed herein.

In an embodiment, the UE (100) when validating the MIB, generates a version of modified MIB by setting the SFN value as the pre-defined constant value (such as 0) and by setting other parameters from received MIB. This avoids the failure of SI validation cause due to mismatch of SFN information between stored MIB and MIB used to generate the DS which the UE (100) is using to validate the SI message.

In an embodiment, the UE (100) performs the SI validation when UE (100) acquires the SI messages upon receiving SI change notification through short message in paging. Alternatively, the Validity of the SI messages and authenticity of the cell is maintained after the UE (100) validates the cell once. The status of the cell's authenticity can be:
configured to expire based on a separate timer per cell or
linked to the validity of the stored System Information message.

The timer for governing the validity of a cell can be configured through at least one of the, the Registration Accept message when the UE (100) first negotiates the security keys for SI validation, RRC message, as part of SIB1 or SIBx carrying the system information.

In an embodiment, the valueTag in si-SchedulingInfo of SIB1 associated with the SIB carrying Security Information does not change when the DS is updated due to the change in at least one of or combination of the following parameters in System Information, but not limiting to:
MIB: SFN information in MIB
SIB1: posSI-BroadcastStatus, si-BroadcastStatus
SIB19: t-Service, NTN-Config (ta-Common, ntn-UlSyncValidityDuration, taCommonDrift, ta-CommonDriftVariant, epochTime, EphemerisInfo)
SIB9: timeInfoUTC

In another embodiment, the SI Change notification through short message in paging is not triggered when the DS in SIB carrying Security information is updated due change in SIB parameters which does not trigger SI change notification upon modification by network.

In an alternate embodiment, in case of SIBs containing parameters which does not trigger a SI change notification or valueTag change when updated (such as SFN in MIB, si-BroadcastStatus in SIB1) are not considered when generating the Digital Signature for these SIBs.

FIG. 19c is schematic diagram illustrating the signaling of security information of MIB, SIB1 and other SIBs as part of SI message container, according to an embodiment as disclosed herein.

In an alternate embodiment, the Security Information is broadcasted as part of the System Information message container carrying other SIBs. The Digital Signature in the security information is generated by taking the following as input, along with security keys, frequency information, cell ID, Timing information:
Content of SIBs scheduled in the SI message,
MIB message
SIB1 message.

In an embodiment, the network schedules different SIBs in different System Information messages having different periodicity. The network signals the security information corresponding to the SIBs scheduled as part of this SI message. The security information carried in each SI message is generated based on the contents of the SIBs scheduled in the SI message. Alternatively, the DS is generated by taking contents of MIB, SIB1 and the SIBs scheduled in the SI message as inputs.

FIG. 19d is schematic diagram illustrating the scheduling of security information of MIB and SIB1 as part of the SIBx and security information of other SIBs, according to an embodiment as disclosed herein.

In an embodiment, the Security Information for MIB and SIB1 is broadcasted in a new SIB message and the Security Information for other SIBs are broadcasted along with the SIB messages in the SystemInformation message container carrying the SIBs. This is illustrated in FIG. 19D. The new SIB carrying the Security information of MIB and SIB1 is broadcasted at higher periodicity to aid the faster acquisition and validation of the Minimum System Information messages. The UE (100) acquires other SIBs based on the requirements of the UE (100). The UE (100) uses the security information present as part of the SystemInformation message container to validate the SIBs scheduled in that SI message.

| | |
|---|---|
| SystemInformation := | SEQUENCE { |
| criticalExtensions | CHOICE { |
| systemInformation | SystemInformation-IEs, |
| criticalExtensionsFuture-r16 | CHOICE { |
| posSystemInformation-r16 | PosSystemInformation-r16-IEs, |
| criticalExtensionsFuture-r18 | CHOICE{ |
| otherSib-SecurityInformation | securityInfo, |

```
          criticalExtensionsFuture SEQUENCE{ }
        }
    }
  }
}
```

Other Sib-Security Information: This field carries the security information containing the Timing information and Digital Signature generated based on the SIBs scheduled in this SystemInformation message container.

FIG. 19e is schematic diagram illustrating the scheduling of security information of MIB and SIB1 as part of a higher periodic SI message container and security information of other SIBs, according to an embodiment as disclosed herein.

Alternatively, the security information for MIB and SIB1 is carried as part of one of the SystemInformation message container and other SI messages containers carry the security information of the corresponding SIBs scheduled in that SI message. In an embodiment, the network indicates which SI message is carrying the security information for MIB and SIB1. Alternatively, the network can implicitly signal the SI message carrying the security information of MIB and SIB1 by configuring the SI message with the lowest period length to carry the security information of MIB and SIB1 so as to reduce the time required for UE (100) to access the cell.

In an embodiment, the network configures the UE (100) on how the Digital Signature is being distributed. This configuration can be provided as part of the NAS signaling during initial registration procedure or signaled as part of SIB1. The different schemes of distribution of Security information can be one or combination of the following:

Option 1: A new SIB carrying the Security information
The Security information can be a common DS generated by taking MIB/SIB1 and other SIBs as inputs
A separate DS for MIB/SIB1 and other SIBs
security information for partial SIs and an parameter indicating which SIBs are considered for generation of DS.

Option 2: The Security information is carried as part of SI message container
DS in SI message container is generated by using MIB, SIB1 and SIBs scheduled in that SI message
DS in SI message container is generated by using only SIBs scheduled in that SI message
Separate DS for each of the SIBs scheduled in the SI message

Option 3: A combination of option 1 and 2 where in the Security information for MIB and SIB1 is signalled as part of a new SIB (SIBx) with higher periodicity and security information for other SIBs are scheduled in the SI message container.

In an embodiment, the SI and/or SIBx carries at least one of the following information for the UE (100) to confirm it acquired the appropriate Digital Signature and the input messages used as an input to generate the digital signature at the network (can be gNB):
SFN
One or more than one SI used in generating the DS (for example, MIB, SIB1 or MIB, SIB1, SIB2 and SIB9 or SIB2, SIB10, SIB13, like so)
Key identity/index.

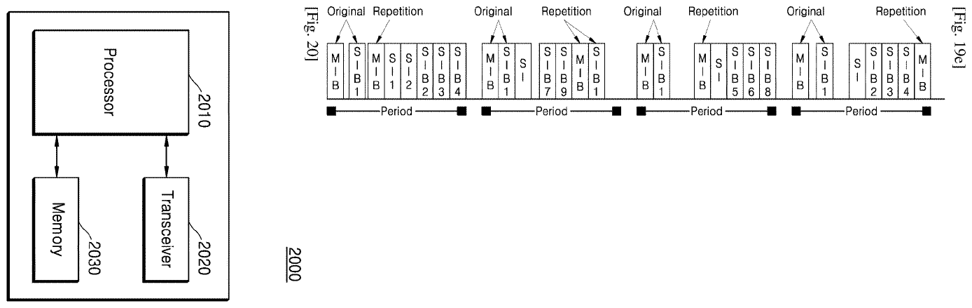

FIG. 20 is a diagram illustrating a network node 2000 according to an embodiment of the disclosure.

Referring to the FIG. 20, the network node 2000 may include a processor 2010, a transceiver 2020 and a memory 2030. However, all of the illustrated components are not essential. The network node 2000 may be implemented by more or less components than those illustrated in FIG. 20. In addition, the processor 2010 and the transceiver 2020 and the memory 2030 may be implemented as a single chip according to another embodiment.

The aforementioned components will now be described in detail.

The processor 2010 may include one or more processors or other processing devices that control the proposed function, process, and/or method. Operation of the network node 2000 may be implemented by the processor 2010.

The processor 2010 may transmit the first system information to the UE in the wireless communication. The processor 1010 determine a method for dividing CBs and a method for rate matching of a PDSCH according to the PDCCH. The processor 1010 may transmit the second system information with the security information of the network node based on at least one scheduling parameter determined from the first system information.

The transceiver 2020 may include a RF transmitter for up-converting and amplifying a transmitted signal, and a RF receiver for down-converting a frequency of a received signal. However, according to another embodiment, the transceiver 2020 may be implemented by more or less components than those illustrated in components.

The transceiver 2020 may be connected to the processor 2010 and transmit and/or receive a signal. The signal may include control information and data. In addition, the transceiver 2020 may receive the signal through a wireless channel and output the signal to the processor 2010. The transceiver 2020 may transmit a signal output from the processor 2010 through the wireless channel.

The memory 2030 may be connected to the processor 2010 and store at least one instruction or a protocol or a parameter for the proposed function, process, and/or method of the network node or base station or network as aforementioned.

The various actions, acts, blocks, steps, or the like in the above flow diagrams may be performed in the order presented, in a different order or simultaneously. Further, in some embodiments, some of the actions, acts, blocks, steps, or the like may be omitted, added, modified, skipped, or the like without departing from the scope of the disclosure.

It should be understood that embodiments described herein should be considered in a descriptive sense only and not for purposes of limitation. Descriptions of features or aspects within each embodiment should be considered as available for other similar features or aspects in other embodiments. The afore-described embodiments may operate in combination when required. For example, the network node and the UE may operate according to a combination of parts of the embodiments.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a user equipment (UE) for determining at least one false network node in a wireless network, the method comprising:
determining that the UE is configured or capable for security protection of at least one system information;
receiving first system information from a cell of at least one network node in the wireless communication;
determining at least one scheduling parameter of second system information for the cell of at least one network node from the first system information, wherein the second system information including security information,
receiving the second system information including the security information of the at least one network node based on the at least one scheduling parameter; and
determining that the at least one network node is false when validation of the at least one of the first system information and the second system information of the cell including the security information is failed.

2. The method of claim 1 further comprising: determining that the at least one network node is genuine when the validation of the at least one of the first system information and the second system information of the cell with the security information is success.

3. The method of claim 1, wherein the determining that the at least one network node is false by validating at least one of the first system information and the second system information with the security information, comprises:
determining whether the at least one network node is false by validating at least one of the first system information and the second system information with the security information; and
performing one of:
reselecting to other cell when the validation of the at least one of the first system information and the second system information of the cell with the security information is failed; or
continuing the connection with cell of the at least one network node when the validation of the at least one of the first system information and the second system information of the cell with the security information is success.

4. The method of claim 3, wherein the continuing the connection with the cell of at least one network node, comprises:
measuring a signal strength for a serving cell and at least one neighboring cell;
determining whether the signal strength of the at least one neighboring cell is larger than the signal strength of the serving cell; and
performing one of:
reselecting to the at least one neighboring cell when the signal strength of the at least one neighboring cell is larger than the signal strength of the serving cell; and discarding the security information of the serving cell and determine security information of the at least one neighboring cell; or
continuing the connection with the serving cell when the signal strength of the at least one neighboring cell is not larger than the signal strength of the serving cell.

5. The method of claim 1, wherein the first system information comprises at least one of a Master Information Block (MIB), a System Information Block index 1 (SIB1) and other System Information Blocks.

6. The method of claim 1, wherein the second system information comprises at least one of Existing System information block (SIB) and New System Information Block (SIBx).

7. The method of claim 1, wherein the at least one scheduling parameter comprises at least one of periodicity of the SIBx, broadcast status of the SIBx, support of an on-demand delivery of SIBx, a scope of security protection or verification in the cell or an area of the wireless network.

8. The method of claim 1, comprising:
transmitting a request message through a dedicated signaling to the at least one network node; and
receiving a response message from the at least one network node through the dedicated signaling comprising the scheduling parameters.

9. A User Equipment (UE) for determining at least one false network node in a wireless network, comprises:
a memory;
a processor;
a validate controller coupled to the memory and the processor configured to:
determine that the UE is configured or capable for security protection of at least one system information;
receive a first system information from a cell of at least one network node in the wireless communication;
determine at least one scheduling parameter of a second system information for the cell of at least one network node from the first system information; wherein the second system information includes a security information,
receive the second system information with the security information of the at least one network node based on the at least one scheduling parameter; and
determine that the at least one network node is false when the validation of the at least one of the first system information and the second system information of the cell including the security information is failed.

10. The UE of claim 9, wherein the validate controller determines that the at least one network node is genuine when the validation of the at least one of the first system information and the second system information of the cell with the security information is success.

11. The UE of claim 9, wherein the validate controller is further configured to:
determine whether the at least one network node is false by validating at least one of the first system information and the second system information with the security information; and
perform one of:
reselect to other cell when the validation of the at least one of the first system information and the second system information of the cell with the security information is failed; or
continue the connection with cell of the at least one network node when the validation of the at least one of the first system information and the second system information of the cell with the security information is success.

12. The UE of claim 11, wherein the validate controller is further configured to:
measure a signal strength for a serving cell and at least one neighboring cell;
determine whether the signal strength of the at least one neighboring cell is larger than the signal strength of the serving cell; and
perform one of:
reselect to the at least one neighboring cell when the signal strength of the at least one neighboring cell is larger than the signal strength of the serving cell; and discarding the security information of the serving cell and determine security information of the at least one neighboring cell; or
continue the connection with the serving cell when the signal strength of the at least one neighboring cell is not larger than the signal strength of the serving cell.

13. The UE of claim 9, wherein the first system information comprises at least one of a Master Information Block (MIB), a System Information Block index 1 (SIB1) and other System Information Blocks.

14. The UE of claim 9, wherein the second system information comprises at least one of Existing System information block (SIB) and New System Information Block (SIBx).

15. The UE of claim 9, wherein the at least one scheduling parameter comprises at least one of periodicity of the SIBx, broadcast status of the SIBx, support of an on-demand delivery of SIBx, a scope of security protection or verification in the cell or an area of the wireless network.
